(19) United States
(12) Patent Application Publication
(10) Pub. No.: US 2025/0209942 A1
(43) Pub. Date: Jun. 26, 2025

(54) SIMULATOR FOR PRACTICING BILATERAL CLEFT LIP AND PALATE SURGERY

(71) Applicant: SIMULARE MEDICAL INC., Toronto (CA)

(72) Inventors: Dale J. PODOLSKY, Toronto (CA); David M. FISHER, Toronto (CA); Karen W. WONG, Toronto (CA); James M. DRAKE, Toronto (CA); Christopher R. FORREST, Ontario (CA); Branavan YASABALA, Ontario (CA); Richard A. HOPPER, Seattle, WA (US)

(21) Appl. No.: 18/851,782

(22) PCT Filed: Mar. 28, 2023
(86) PCT No.: PCT/CA2023/050417

§ 371 Date: Sep. 27, 2024

Related U.S. Application Data
(60) Provisional application No. 63/324,528, filed on Mar. 28, 2022.

(51) Int. Cl. G09B 23/30

(52) U.S. Cl. CPC G09B 23/30

(57) ABSTRACT

A simulator for practicing bilateral cleft lip and palate surgery, comprising: a simulated premaxilla bone; and a simulated prolabium tissue separably attached to the simulated premaxilla bone. Such simulator being configured specifically to reflect the physical elements of a cleft lip and palate and comprising elements that are formed from materials that are similar in characteristics to the corresponding elements of a human cleft lip and palate. Several elements are further formed individually and connected in manner that forms layers of elements as well as positioning of elements and interactions between elements that can assist with training of cleft lip and palate surgical skills. Surgical procedures that can be performed upon a human cleft lip and palate may be performed upon such simulator utilizing the same surgical tools and steps as are utilized upon a human patient, and having the same feel as performing surgery upon a human subject, which enhances learning of surgical skills.

### TECHNICAL FIELD OF THE INVENTION

The present invention relates to surgical simulation tools and methods for making and using same, and more particularly for surgical simulation tools for procedures involving bilateral cleft lip and palate.

### BACKGROUND OF THE INVENTION

It is known in the art of surgical education and training to employ physical simulators to allow surgeons and students to practice techniques involved in successful surgical outcomes, not only to enhance subsequent operating room performance but also to enable improved competency-based surgical student assessment. However, physical simulator models are commonly overly-simplistic and suffer from a lack of useful reflection of actual anatomical details that would be encountered during surgical procedures conducted on patients, resulting in reliance on computer model and cadaver-based training. Computer models have obvious limitations as surgical training tools, and cadavers with the requisite physical conditions may be difficult to obtain.

This deficiency in the availability of useful physical simulator models is also evident in the context of cleft lip and palate procedures. Computer models again are not as desirable as physical models, but cadavers with cleft lip and palate conditions may be highly inaccessible.

Canadian Patent No. 2,973,242 to Podolsky et al. describes a physical simulator for practicing trans-oral surgery, comprising: a simulated hard palate; a simulated soft palate musculature adjacent to the simulated hard palate; and a simulated mucosal layer covering at least a portion of the simulated hard palate and at least a portion of the simulated soft palate musculature, wherein the simulated mucosal layer is configured to conform to and follow the contours of surface features of the covered portions of the simulated hard palate and simulated soft palate musculature, wherein the simulated mucosal layer is thicker over the simulated hard palate than over the simulated soft palate musculature.

While some initial efforts have been made in the field to create more useful, detailed physical models for practice and training, a deficiency exists in the specific context of bilateral cleft lip and palate surgical procedures. What is needed is a simulator for bilateral cleft lip and palate surgical procedures that: reflects the anatomical complexity involved in such biological conditions; is specifically configured as a simulator tool specific to such biological condition; and wherein the elements have an interaction and layering that reflects the condition and creates a simulated interaction, layering and feel similar to that of the condition and as encountered in surgical processes performed relating to such condition.

### SUMMARY OF THE INVENTION

According to a first broad aspect of the present invention, there is provided a simulator for practicing bilateral cleft lip and palate surgery, comprising: a simulated premaxilla bone; and a simulated prolabium tissue separably attached to the simulated premaxilla bone.

In some exemplary embodiments of the first broad aspect of the present invention, the simulated premaxilla bone is part of a simulated bony cartridge. A simulated nose cartilage may further be attached to the simulated bony cartridge, with a portion of the simulated nose cartilage attached to the simulated premaxilla bone. In some embodiments, a simulated orbicularis oris muscle is also attached to the simulated bony cartridge.

In some exemplary embodiments of the first broad aspect of the present invention, the simulator further comprises a multilayer simulated anterior skin comprising the simulated prolabium tissue, the simulated prolabium tissue comprising a pocket for receiving a simulated fat tissue.

In some exemplary embodiments of the first broad aspect of the present invention, the simulator further comprises simulated soft palate right and left tensor veli palatini (TVP) muscles, simulated right and left palatopharyngeus and palatoglossus (PP+PG) muscles, simulated right and left levator veli palatini (LVP) muscles, a simulated oral cavity (OC), and a simulated superior constrictor (SC) muscle. The simulated right and left palatopharyngeus and palatoglossus muscles may be attached to the simulated right and left levator veli palatini muscles to form a muscle assembly, and the muscle assembly then attached to the simulated bony cartridge to form a muscle/bony cartridge assembly. A simulated fat layer may also be applied to the muscle assembly but not applied to the simulated bony cartridge. The simulated soft palate right and left tensor veli palatini muscles are preferably attached to the simulated bony cartridge. The simulated superior constrictor muscle is preferably attached to the simulated oral cavity to form a muscle/cavity assembly, and wherein the muscle/cavity assembly is preferably attached to the muscle/bony cartridge assembly.

In some exemplary embodiments of the first broad aspect of the present invention, the simulator further comprises a simulated mucosa applied on all exposed surfaces.

In the embodiments of the present invention a variety of materials may be utilized. Some materials are expressly identified herein, however other materials having similar characteristics and properties may also be utilized to form elements of the present invention. As examples: elements that are simulations of soft tissue may be formed of any polymer, for example, such as silicone or urethane. The soft tissue elements may be formed of such material by casting (e.g., in a mold), 3D printing, or any other process. Examples of silicone that may be utilized to form simulated soft tissue elements includes DragonSkin™ (Smooth-On), EcoFlex™ (Smooth-On), platinum cured silicones. Simulated bone elements can be formed from materials such as polylactic acid, acrylonitrile butaediene styrene (ABS) or other polymers. The bone elements may be formed of such materials by casting using molds in ABS or other polymers, or by 3D printing by polylactic acid or other materials utilizable for 3D printing. The 3D printed simulated bone elements may be formed using a fused deposition type of 3D printer or a stereolithographic or light based curing type of 3D printer. Descriptions of the use of particular materials set out herein are examples of materials used in some embodiments of the present invention, and other materials could be utilized in other embodiments of the present invention.

The present invention offers a benefit over know prior art in that it is configured specifically to reflect the key physical elements of a cleft lip and palate and the interactions between such elements.

Another benefit of the present invention over the known prior art is that the elements of the simulator (e.g., bone, tissue, and other elements) are formed of materials that have physical characteristics that are similar to those of the physical elements that they represent. For example, the bone elements are formed of materials that reflect the density, hardness and other characteristics of human facial bones, the tissue elements are formed of materials that have the flexibility, elasticity and other characteristics of human facial tissue, and other elements in the simulator are also formed of materials that have characteristics that have similarities to the physical human facial elements that they represent.

Yet another benefit of the present invention over the known prior art is that the configuration of the elements of the simulator reflect the anatomical complexities of a human face incorporating a cleft lip and palate.

Another benefit of the present invention over the known prior art is that it is configured through a layering of elements to comprise the simulator. Elements are formed individually and then configured in a manner whereby elements are attached to other elements in manner similar to the configuration and connections of a human cleft lip and palate. The effect of the layering is to create elements that are not only positioned in a similar manner to a human cleft lip and palate, but that have similar connections and interactions in relation to each other in a similar manner to the elements of a human cleft lip and palate. In particular, the ability to move certain elements within the simulator, and to move such elements in relation to other elements, during a surgical procedure performed upon the simulator will be similar to the experience of performing a surgical procedure upon a human cleft lip and palate. The layers of elements that must be addressed in a surgical procedure upon a human cleft lip and palate is reflected in the simulator. Additionally, the action of detaching elements from other elements within the simulator during a surgical procedure performed upon the simulator will be similar to the experience of performing a surgical procedure upon a human cleft lip and palate.

A still further benefit of the present invention over the prior art is that it allows for use of the simulator to provide not only a simulation of the manipulation of elements in a surgical cleft lip and palate procedure, but also allows for the user to experience a similar feel of the elements in involved in such a surgical procedure. This facilitates learning that better reflects the realities of performing a surgical procedure on a human cleft lip and palate, which can reduce the likelihood of errors by a surgeon who has trained their surgical skills by using the simulator.

The formation of the elements of the simulator further promotes other forms of learning relating to the cleft lip and palate condition, such as visual identification of elements and positioning of elements, interactions of elements, and other types of learning relating to cleft lip and palate conditions.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the drawings provided herein all reference to elements and components of human physical cleft lips and palates are references to simulated elements as incorporated in the present invention disclosed herein. In the accompanying drawings, which illustrate exemplary embodiments of the present invention:

FIG. 1 is a perspective view of a nose cartilage mold within a clamp.

FIG. 2 is a perspective view of applying silicone to cover the septal cartilage mold.

FIG. 3 is a perspective view of separating a mold.

FIG. 4 is a perspective view of attaching the upper laterals to the bony cartridge.

FIG. 5 is a perspective view of applying a simulated fat layer.

FIG. 6 is a perspective view of drop-drying the muscle molds.

FIG. 7 is a perspective view of cured silicone below a mesh.

FIG. 8 is a perspective view of a injecting a think layer of Fx-Pro into a base mould to form an anterior skin element.

FIG. 9 is a perspective view of a metal piece placed upon uncured silicone.

FIG. 10 is a perspective view of injecting silicone into a tongue portion of a mold.

FIG. 11 is a perspective view of mesh placement.

FIG. 12 is a perspective view of silicone extruding out of open air ports of a mold.

FIG. 13 is a perspective view of filling a prolabium pocket with silicone.

FIG. 14 is a perspective view of the lip and nostril areas of a skin element.

FIG. 15 is a perspective view of adding coating to the back of the lip and prolabium elements.

FIG. 16 is a perspective view of overflowing the mold to remove silicone surface tension.

FIG. 17 is a perspective view of a completed simulated fat layer.

FIG. 18 is a perspective view of simulated tensor veli palatini muscles placement.

FIG. 19 is a perspective view of simulated superior constrictor muscle and simulated oral cavity placement.

FIG. 20 is a perspective view of injecting silicone into the simulated great palatini foramen.

FIG. 21 is a perspective view of a bilateral cleft lip cartridge inserted into the base.

FIG. 22 is a perspective view of a cartridge being inserted into the base and partial configuration of the facial components.

FIG. 23 is a perspective view of a simulator whereupon surgical tools are utilized for trans-oral surgery in accordance with an embodiment of the present invention.

FIG. 24 is an anterior view of a superficial skin layer component of the present invention in accordance with one embodiment of the present invention.

FIG. 25 is an inferior view of a superficial skin layer component of the present invention in accordance with one embodiment of the present invention.

FIG. 26A is a top perspective view of the cleft lip and palate configuration of a cartridge in accordance with an embodiment of the present invention.

FIG. 26B is a side perspective view of the cleft lip and palate configuration of a cartridge in accordance with an embodiment of the present invention.

FIG. 26C is a side perspective view of the cleft lip and palate configuration of a cartridge in accordance with an embodiment of the present invention.

FIG. 26D is a front perspective view of the cleft lip and palate configuration of a cartridge in accordance with an embodiment of the present invention.

FIG. 26E is a front side perspective view of the cleft lip and palate configuration of a cartridge in accordance with an embodiment of the present invention.

FIG. 26F is a top front perspective view of the cleft lip and palate configuration of a cartridge in accordance with an embodiment of the present invention.

FIG. 27A is a perspective view of a simulator configuration of a soft palate musculature, cartilage and a hard palate enclosed by mucosal tissue in accordance with one embodiment of the present invention.

FIG. 27B is an upper perspective view of a simulator configuration of a soft palate musculature, cartilage and a hard palate enclosed by mucosal tissue in accordance with one embodiment of the present invention.

FIG. 27C is a side perspective view of a simulator configuration of a soft palate musculature, cartilage and a hard palate enclosed by mucosal tissue in accordance with one embodiment of the present invention.

FIGS. 28A-I are perspective views of a cartridge in accordance with one embodiment of the present invention.

FIG. 29 is an upper perspective view of a simulator configuration of a palate musculature, cartilage and a hard palate enclosed by mucosal tissue in accordance with one embodiment of the present invention.

FIG. 30 is a perspective view of a simulator configuration of a cartilage attached to a hard palate in accordance with one embodiment of the present invention.

FIG. 31 is a perspective view of a simulator configuration of a mucosal layer attached to a soft palate musculature, cartilage and hard palate in accordance with one embodiment of the present invention.

FIG. 32 is a perspective view of a simulator configuration of a soft palate musculature, nasal cartilage and superior constrictor muscle attached to a hard palate and cranial base in accordance with one embodiment of the present invention.

FIG. 33 is a perspective view of a simulator configuration of a hard palate and cranial base in accordance with one embodiment of the present invention.

FIG. 34 is a top perspective view of a simulator configuration of a hard palate and a cranial base in accordance with one embodiment of the present invention.

FIG. 35 is a perspective view of a simulator configuration of a soft palate musculature and nasal cartilage attached to the cranial base in accordance with one embodiment of the present invention.

FIG. 36 is perspective view of a portion of a simulator configuration of a soft palate musculature attached to a cranial base, showing an oral head of a palatopharyngeus muscle located to one side of a levator veli palatini muscle in accordance with one embodiment of the present invention.

FIG. 37 is a perspective view of a simulator configuration of a soft palate musculature, nasal cartilage and superior constrictor muscle attached to the hard palate and cranial base in accordance with one embodiment of the present invention.

FIG. 38 is a perspective view of a portion of a simulator configuration of a soft palate musculature and superior constrictor muscle in accordance with one embodiment of the present invention.

FIGS. 39A-C are perspective views of a palatopharyngeus muscle, in accordance with one embodiment of this present invention.

FIGS. 40A-D are perspective views of a palatoglossus muscle, in accordance with one embodiment of this present invention.

FIGS. 41A-C are perspective views of a musculus uvula, in accordance with one embodiment of this present invention.

FIGS. 42A-J are perspective views of a levator veli palatini muscle in accordance with one embodiment of the present invention.

FIG. 43 is a perspective view of a levator veli palatini muscle attached to a cranial base in accordance with one embodiment of the present invention.

FIGS. 44A-J are perspective views of a tensor veli palatini muscle in accordance with one embodiment of the present invention.

FIG. 45 is a perspective view of a tensor veli palatini muscle attached to a cranial base in accordance with one embodiment of the present invention.

FIGS. 46A-F are perspective views of a superior constrictor muscle in accordance with one embodiment of the present invention.

FIG. 47 is a perspective view of a superior constrictor muscle inset within an oral cavity in accordance with one embodiment of the present invention.

FIGS. 48A-F are perspective views of a nasal cartilage in accordance with one embodiment of the present invention.

FIG. 49 is a perspective view of a nasal cartilage attached to a hard palate in accordance with one embodiment of the present invention.

FIG. 50 is a perspective view of an Eustachian tube, nasal cartilage, and a soft palate musculature attached to a hard palate and cranial base in accordance with one embodiment of the present invention.

FIG. 51 is a perspective view of a soft palate musculature, nasal cartilage, superficial layer of skin, and a hard palate, enclosed by a mucosal tissue in accordance with one embodiment of the present invention.

FIG. 52 is a perspective view of a soft palate musculature, nasal cartilage, superficial layer of skin and superior constrictor muscle attached to a hard palate and cranial base in accordance with one embodiment of the present invention.

FIGS. 53A-F are perspective views of a superficial layer of skin in accordance with one embodiment of the present invention.

FIG. 54 is a perspective view of a superficial layer of skin attached to a cranial base in accordance with one embodiment of the present invention.

FIG. 55 is a perspective view of an Orbicularis Oris musculature, fat tissue, and nasal cartridge embedded and attached to a superficial layer of skin in accordance with one embodiment of the present invention.

FIG. 56 is a perspective view of an Orbicularis Oris musculature, fat tissue, and nasal cartridge embedded and attached to a superficial layer of skin attached to a cranial base in accordance with one embodiment of the present invention.

FIGS. 57A-F are perspective views of an oral cavity in accordance with one embodiment of the present invention.

FIG. 58 is a perspective view of an oral cavity attached to a cranial base in accordance with one embodiment of the present invention.

FIGS. 59A-F are perspective views of an oral cavity lid in accordance with one embodiment of the present invention.

FIG. 60 is a perspective view of an oral cavity attached to an oral cavity lid in accordance with one embodiment of this invention.

FIG. 61 is a perspective view of a cartridge of a simulator in accordance with one embodiment of the present invention.

FIG. 62A is a perspective view of a cartridge having the oral cavity lid attached in accordance with one embodiment of the present invention.

FIG. 62B is a perspective view of a cartridge having the oral cavity lid detached in accordance with one embodiment of the present invention.

FIG. 63 is a view of a cartridge incorporating a superficial layer of skin in accordance with one embodiment of the present invention.

FIG. 64 is a view of a cartridge incorporating a superficial layer of skin with fat tissue and Orbicularis Oris musculature in accordance with one embodiment of the present invention.

FIG. 65 is an exploded view diagram of a cartridge in accordance with an embodiment of the present invention.

FIG. 66 is a perspective view of a soft palate musculature and superior constrictor muscle attached to a hard palate and cranial base in accordance with one embodiment of the present invention.

FIG. 67A is a perspective view of a hard palate and cranial base in accordance with one embodiment of the present invention.

FIG. 67B is a perspective view of a hard palate and cranial base in accordance with one embodiment of the present invention.

FIG. 67C is a perspective view of a hard palate and cranial base in accordance with one embodiment of the present invention.

Exemplary embodiments will now be described with reference to the accompanying drawings.

### DETAILED DESCRIPTION OF EXEMPLARY EMBODIMENTS

The present invention is a simulator for practicing bilateral cleft lip and palate surgery, comprising: a simulated premaxilla bone; and a simulated prolabium tissue separably attached to the simulated premaxilla bone. Such simulator being configured specifically to reflect the physical elements of a cleft lip and palate and comprising elements that are formed from materials that are similar in characteristics to the corresponding elements of a human cleft lip and palate and an assembly. Several elements are further formed individually and connected in manner that forms layers of elements as well as positioning of elements and interactions between elements that can assist with training of cleft lip and palate surgical skills and other learning and skills training relating to cleft lip and palate conditions. Surgical procedures that can be performed upon a human cleft lip and palate may be performed upon such simulator utilizing the same surgical tools and steps as are utilized upon a human patient, and having the same feel as performing surgery upon a human subject, which enhances learning of surgical skills.

Throughout the following description, specific details are set forth in order to provide a more thorough understanding of the invention, and to persons skilled in the art. However, well known elements, that would be known to persons skilled in the art, may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to a simulator for practicing bilateral cleft lip and palate surgery, comprising a simulated premaxilla bone and a simulated prolabium tissue separably attached to the simulated premaxilla bone. In the exemplary embodiments described hereinbelow, the simulated premaxilla bone is part of a simulated bony cartridge. A simulated nose cartilage is attached to the simulated bony cartridge, with a portion of the simulated nose cartilage attached to the simulated premaxilla bone. A simulated orbicularis oris muscle is also attached to the simulated bony cartridge.

The exemplary simulator described hereinbelow further comprises a multilayer simulated anterior skin comprising the simulated prolabium tissue, the simulated prolabium tissue comprising a pocket for receiving a simulated fat tissue. The simulator further comprises simulated soft palate right and left tensor veli palatini (TVP) muscles, simulated right and left palatopharyngeus (PP) and palatoglossus (PG) muscles (collectively the PP+PG muscles), simulated right and left levator veli palatini (LVP) muscles, a simulated oral cavity (OC), and a simulated superior constrictor (SC) muscle. The simulated right and left PP+PG muscles are attached to the simulated right and left LVP muscles to form a muscle assembly, and the muscle assembly then attached to the simulated bony cartridge to form a muscle/bony cartridge assembly. A simulated fat layer is also applied to the muscle assembly but not applied to the simulated bony cartridge. The simulated soft palate right and left TVP muscles are attached to the simulated bony cartridge. The simulated SC muscle is attached to the simulated OC to form a muscle/cavity assembly, and wherein the muscle/cavity assembly is attached to the muscle/bony cartridge assembly. The simulator further comprises a simulated mucosa applied on all exposed surfaces.

Following is a detailed exemplary method for creating a simulator in accordance with one exemplary embodiment of the present invention, other embodiments of the present invention are also possible.

All references to elements of a cleft lip and palate herein are references to simulated elements, created in accordance with the present invention, as described herein. The word “simulated” does not appear before references to all such elements, but should be read into each reference of such elements, as all elements of the simulator are simulated elements.

There are several processes that can be applied to forming the elements of the present invention. Some of these processes are described herein. Each element is created individually, and then assembled with the other elements to form the simulator, as described herein. Generally the elements are added to the assembly of the simulator individually in accordance with steps that result in some elements being positioned in a layered manner (whereby elements are positioned above or below other elements). The connections between the elements are further formed in a manner to create interactions between the elements, for example movement in relation to other elements, processes required for detaching elements one from another. The present invention may be anatomically accurate, or close thereto, when compared to a human cleft lip and palate. However, the simulator is further created to reflect connections, positioning of elements and interactions between elements that are similar to a cleft lip and palate.

Moreover, as the elements of the simulator are created individually and assembled by positioning and connecting the elements, the positions and connections of such elements can be modified in versions of the simulator. Such variations will further affect the interactions of the elements with each other, and the experience of a user who performs a surgical procedure or other learning upon the simulator. A skilled reader will recognize that these characteristics and modifiability of the present invention allows for versions of the present invention to be utilized for a variety of purposes relating to learning, skills training and other purposes relating to cleft lip and palate surgeries and other activities.

### Elements and Assembly

Many methods and processes may be applied to the creation of the elements of the simulator, and to the assembly thereof. For example, elements may be generated by 3D printing, molds and other processes. The following provides some examples or processes to create and assemble the elements of the present invention to form embodiments of the present invention. Other processes or variations of the processes described below are possible to create and assemble the simulator of the present invention, moreover, other elements than those described below can be formed and incorporated in the assembly of the present invention.

### Bony Cartridge

In embodiments of the present invention a cartridge may be formed, and may incorporate a section that simulates bone in structure and other characteristics (e.g., density, flexibility, etc.). There are several processes and materials that may be utilized to form such bony cartridge. One such process is described below.

It is possible to form such bony cartridge using 3D printing, for example 3D printer such as an Ultimaker™ printer may be utilized, as may other types of 3D printers. The print bed of the 3D printed may be cleaned, and polylactic acid (PLA) filament may be present on the spool. A computer program for facilitating 3D printing, for example, such as Cura™ program or other software, may be utilized. A bilateral cleft cartridge.stl file, being a file that has been created by the inventors of the present invention, shall be utilized by such software to cause the 3D printer to generate the bony cartridge element. The file is oriented so that the rails are horizontal and the palate surface is visible from the top to improve print quality. The bony cartridge may be copied until there are up to four cartridges present on the 3D printer bed and such bony cartridges may be organized to fit with equal spacing.

Possible settings for the bony cartridge may be as follows, however these are settings for one embodiment, other values may also be applied to create the bony cartridge for other embodiments of the present invention:
Layer height: 0.15 mm
Infill: 20%
Infill (support blocker): 100% at Palatini Bone and Premaxilla
Generate support: On
Support infill extruder: Extruder 1 (PLA)
Support interface extruder: Extruder 2 (polyvinyl alcohol (PVA))

When the print process is completed, the bony cartridges are carefully remove from the print bed. Some of the easily accessible support may be manually removed using pliers. The cartridges are then placed in a warm water bath for about 24 hours to dissolve the PVA support interface. Such supports may be incorporated into the printing whereby multiple elements of the bony cartridge may be printed collectively, and the supports will exist between such elements. To detach the elements from each other the elements are removed from the supports. The supports may be discarded after they are detached from the elements. The bony cartridge is allowed to dry for a minimum of 8 hours, and any supports not dissolved may be removed with pliers.

### Nose Cartilage

There are a variety of processes that be applied to assemble the nose cartilage of the present invention. Some examples are described herein.

For each lip portion, one nose cartridge mold (three parts) and one C-clamp are required for the exemplary embodiment. Also required are a stirring stick, a medium mixing container, and a 10 mL syringe. The consumables for each lip portion are a volume of Ecoflex™ 50 part A, an equal or substantially equal volume of Ecoflex 50 part B, and white pigment. A volume in the range of about 2-5 mL of Ecoflex for each lip portion may be sufficient for one cartilage mold for one embodiment of the present invention, however other volumes may be utilized for other embodiments of the present invention.

As one option, the molds are clamped, ensuring that the fill port is not covered by the clamp. For each lip cartilage, combine into the mixing container:
Ecoflex 50 part A
Ecoflex 50 part B
Dab of White pigment in a volume that achieves opaque dyeing

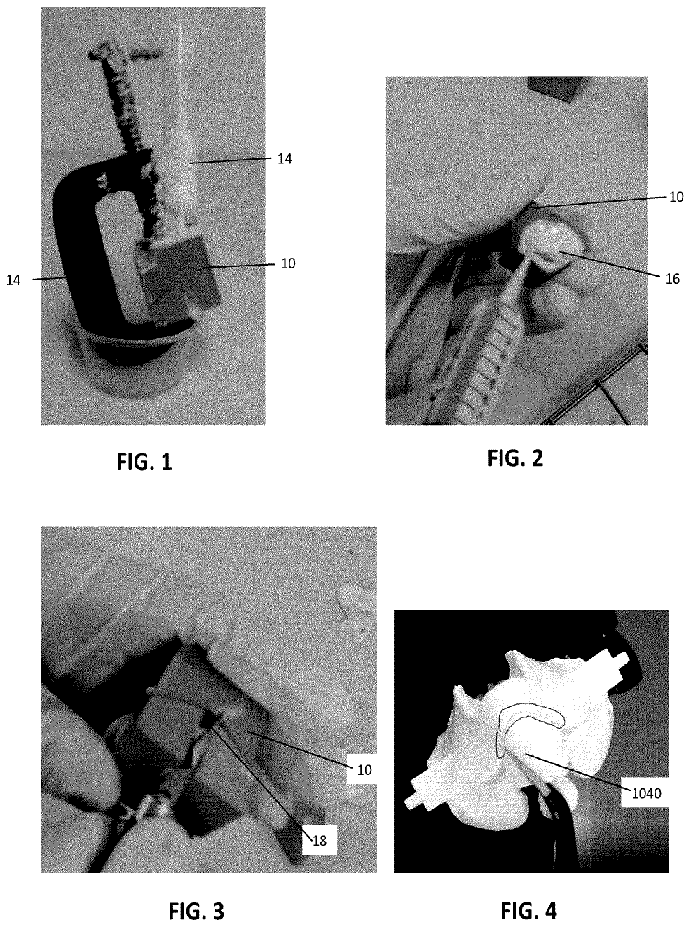

Mix thoroughly using the stir stick. De-gas in a vacuum chamber until the uncured silicone deflates, and wait an additional 30 seconds to remove excess trapped air. The silicone is then aspirated into the syringe and injected into the molds, filling until the silicone starts to escape from the sides. The remaining silicone is placed in the syringe 14 and injected into the fill port of the mold 10, as shown in FIG. 1. The mold may be positioned so as to be held in a closed position by a clamp 12. The silicone is allowed to cure for approximately one hour or any other cure time as indicated by the manufacturer's technical data sheet. The mold is then slowly opened with a pry tool, knife or flat-head screwdriver.

In an alternative optional process, for each lip cartilage, combine the following into the mixing container:
Ecoflex 50 part A
Ecoflex 50 part B
Dab of White pigment in a volume that achieves opaque dyeing
One or more drops of Thi-Vex™ (this amount should be increased with more molds)

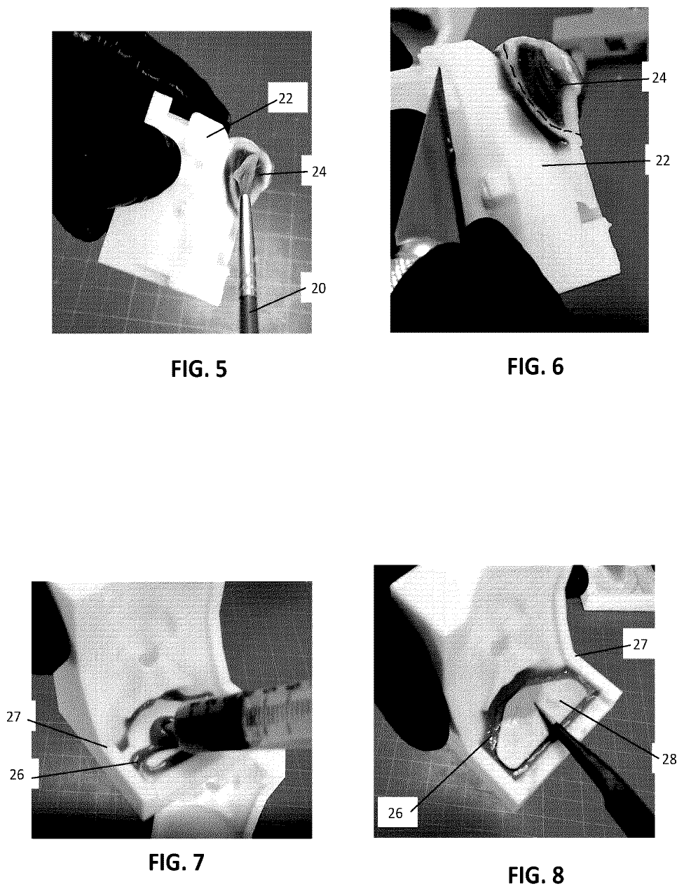

Mix thoroughly using the stir stick. De-gas in a vacuum chamber until the uncured silicone deflates, and wait an additional 30 seconds to remove excess trapped air. The silicone is then aspirated into the syringe. As shown in FIG. 5, a silicone covering 16 is applied on each of the three parts of the mold 10, using the outline of the mold as a guide. The molds are then clamped, and if any silicone is escaping from the sides and/or the fill port additional silicone injection may be required to ensure that the mold is full of silicone. This is allowed to cure for about one hour or other curing time as suggested by the manufacturer's technical data sheet, and then the mold is slowly opened with a pry tool, knife or flat-head screwdriver.

### Nose Cartilage Post-Mold

Required consumables are primer, Loctite™ glue, and the simulated nose cartilage from the previous steps. The excess silicone is trimmed from around the mold, and, as shown in FIG. 3, the mold 10 is carefully separated 18 using a pry tool, such as a knife or flat-head screwdriver, allowing removal of the nose cartilage from the mold. Flashing is cut away using a pair of snippers, and the cartilage is laid on a clean paper towel. The cartilage and corresponding bony surface of the perpendicular plate are then coated with primer. After the primer has dried, glue is applied to the surface nose cartilage to be attached to the lip cartridge, applying only as much glue as is necessary to achieve adherence of the nose cartilage to the lip cartridge where the glue is applied. Using tweezers, the nose cartilage is carefully placed on the glued surface, as shown in FIG. 4.

### Orbicularis Oris (Lip) Muscle

Consumables for this stage include mesh, and the following (for about 13 skin sets): a volume of Ecoflex-30 part A, an equal or substantially equal volume of Ecoflex-30 part B, drops of hearty pigment in a volume that is adequate for opaque dyeing, a volume of Ecoflex Gel part A that is approximately half the volume of the Ecoflex-30 that is utilized, a volume Ecoflex Gel part B that equal or substantially equal to the volume of Ecoflex Gel part A that is utilized, and yellow pigment in a volume that is adequate for translucent dyeing sufficient for a set of molds. As an example, the volume of the Ecoflex-30 utilized may be around 20 mL, and the volume of Ecoflex Gel that is utilized may be around 10 mL or other volumes may be utilized. The simulated orbicularis orbis muscle is created using an orbicularis muscle mold, the mold is coated with a combination of a mesh, a muscle-like silicone layer and a silicone fatty layer. The positive orbicularis mold is then inserted on the side walls of the skin molds. The mold is filled with skin like silicone as shown in FIG. 6. Once cured the orbicularis muscle mold can be removed creating a cavity. The cavity is filled with silicone to resemble muscle.

The mesh is cut in the shape of the muscle mold, and specifically the upper half of the mold. For the lip cartilages, a volume of Ecoflex-30 part A, an equal or substantially equal volume of Ecoflex-30 part B, and drops of hearty pigment adequate for opaque dying are combined in a mixing container and mixed thoroughly. As an example, the volume of Ecoflex-30 that is utilized may be about 10 mL or another volume, and the volume of hearty pigment used may be approximately 10 drop or another volume. The product is de-gassed in a vacuum chamber until the silicone deflates. As shown in FIG. 5, a paintbrush 20 is then used to coat the mesh onto the muscle mold 22, followed by curing for about 30 minutes (ensuring that the mesh is in place during the curing process). A volume of Ecoflex-30 part A, an equal or substantially equal volume of Ecoflex-30 part B, and drops of hearty pigment adequate for opaque dyeing are combined in a mixing container and mixed thoroughly. As an example, the volume of Ecoflex-30 that is utilized may be about 10 mL or another volume, and the volume of hearty pigment used may be approximately 10 drop or another volume. In some embodiments of the present invention this may product up to 13 skin sets. The product is de-gassed in a vacuum chamber until the silicone deflates. A paintbrush is then used to coat this second layer in the muscle mold, curing for about 30 minutes or any other curing time as is suggested by the manufacturer's technical data sheet. For the next 13 skin sets, a volume of Ecoflex Gel part A, an equal or substantially equal volume of Ecoflex Gel part B, and the yellow pigment adequate for translucent dyeing are combined in a mixing container and mixed thoroughly. As an example, the volume of Ecoflex Gel that is utilized may be about 10 mL or another volume. The product is de-gassed in a vacuum chamber until the silicone deflates. Again, a paintbrush is used to coat the muscle mold, ensuring an even coat, and the muscle molds are placed over medicine cups for curing. After curing for about 30 minutes or any other cure time as suggested by the manufacturer's technical data sheet, excess silicone is removed.

### Anterior Skin Mold Part 1

Anterior simulated skin elements are created in stages, as described hereinbelow.

For 5 skin molds, consumables include a volume of Dragon Skin™ FX-PRO™—Part A, an equal or substantially equal volume of Dragon Skin FX-PRO—Part B, skin pigment adequate for opaque dyeing, mesh and a metal component. As an example, the volume of Dragon Skin FX-PRO utilized may be about 10 mL or another volume, and about 0.2 mL of skin pigment may be utilized or another volume. The silicone is prepared by measuring a volume of Dragon Skin FX-PRO—Part A, an equal or substantially equal volume of Dragon Skin FX-PRO—Part B, and skin pigment adequate for opaque dyeing in a mixing container, mixing well with a stir stick, followed by de-gassing in a vacuum chamber. As an example, the volume of Dragon Skin FX-PRO utilized may be about 5 mL or another volume, and about 0.1 mL of skin pigment may be utilized or another volume. This is aspirated and the silicone 27 injected, specifically by filling a small syringe and injecting silicone into each mold part 26, as shown in FIG. 7. Wait for any bubbles to rise to the surface, and if necessary remove bubbles manually with a needle.

Allow this to cure for about 40 minutes or such other curing time as suggested by the manufacturer's technical data sheet.

Further silicone is prepared by measuring a volume of Dragon Skin FX-PRO—Part A, an equal or substantially equal volume of Dragon Skin FX-PRO—Part B, and a volume of skin pigment adequate for opaque dyeing in a mixing container. As an example, the volume of Dragon Skin FX-PRO utilized may be about 5 mL or another volume, and about 0.1 mL of skin pigment may be utilized or another volume. The mesh is applied, and the mesh is painted with the silicone, followed by application of the metal component 28, as shown in FIG. 8. Curing follows for about 40 minutes or another curing time as may be indicated in the manufacturer's technical data sheet.

### Anterior Skin Mold Part 2

Consumables for this stage, include a volume of Dragon Skin FX-PRO—Part A, an equal or substantially equal volume of Dragon Skin FX-PRO—Part B, and mucosa pigment adequate for translucent dyeing sufficient. As an example, to product about 5 skin molds the volume of Dragon Skin FX-PRO utilized may be about 5 mL or another volume.

Silicone is prepared by measuring a volume of Dragon Skin FX-PRO—Part A, an equal or substantially equal Dragon Skin FX-PRO—Part B, and mucosa pigment in a volume adequate for translucent dyeing in a small mixing container, mixing well with a stir stick and de-gassing in a vacuum chamber. As an example, the volume of Dragon Skin FX-PRO utilized may be about 5 mL or another volume.

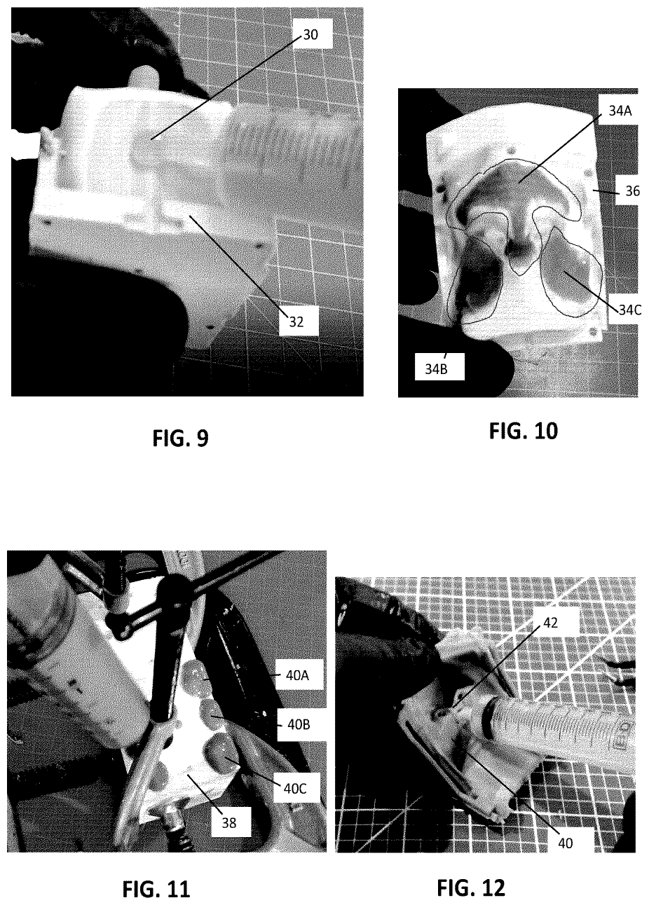

Aspiration and injection of the silicone 30 follows, specifically filling a small syringe and injecting silicone into each tongue area of the mold 32, as shown in FIG. 9. Wait for any bubbles to rise to surface, and if necessary remove the bubbles manually with a needle. Curing follows for about 40 minutes or such other curing time as may be indicated in the manufacturer's technical data sheet.

### Anterior Skin Mold Part 3

Consumables for this stage include mesh, rubbing alcohol, and (for 5 anterior skin molds) a volume of EcoFlex 10 part A, an equal or substantially equal volume of EcoFlex 10 part B, a volume of skin pigment, and a volume of Thi-Vex adequate to increase viscosity. As an example, the volume of EcoFlex utilized may be about 20 mL or another volume, and about 0.4 mL of skin pigment and 1 drop of Thi-Vex may be utilized or other volumes.

The mesh is cut in the shape of the lips and prolabium on each mold, the shape of the mesh cut along the vermilion. A volume of Ecoflex-20 part A, an equal or substantially equal volume of Ecoflex-20 part B, a volume of Thi-Vex adequate to increase viscosity, and a volume of skin pigment adequate for opaque dyeing are combined in a mixing container and mixed thoroughly, then de-gassed in a vacuum chamber until the silicone deflates. As an example, for approximately 5 molds, the volume of EcoFlex-20 utilized may be about 10 mL or another volume, and about 0.2 mL of skin pigment and about 1 drop of Thi-Vex may be utilized or other volumes. The silicone is aspirated into a syringe. The mold areas are coated with the silicone, with a thick coat applied to the lip area of the front face of the mold, curing for 30 minutes or such other curing time as may be indicated in a manufacturer's technical data sheet.

For up to 5 molds, a volume of Ecoflex-20 part A, an equal or substantially equal volume of Ecoflex-20 part B, and a volume of skin pigment adequate for opaque dyeing are combined in the mixing container and mixed thoroughly, followed by de-gassing in a vacuum chamber until the silicone deflates. As an example, for approximately 5 molds, the volume of EcoFlex-20 utilized may be about 10 mL or another volume, and about 0.1 mL of skin pigment may be utilized or another volume.

A paintbrush is used to coat the mesh onto the mold 36, including the front lip area, rear lip area, and top prolabium, 34A, 34B, 34C, as shown in FIG. 10. Curing for about 30 minutes or another curing time as suggested in the manufacturer's technical data sheet, and then removing any excess silicone. Removing excess silicone is important between the lips to allow the mold to easily close for injection, and at the base of the prolabium to ensure it does not block the air port.

### Anterior Skin Mold Part 4

Consumables for this stage include a volume of EcoFlex 20 part A, an equal or substantially equal volume of EcoFlex 20 part B, and a volume of skin pigment adequate for opaque dyeing. As an example, for approximately 1 mold, the volume of EcoFlex 20 utilized may be about 15 mL or another volume, and about 0.3 mL of skin pigment may be utilized or another volume.

The molds are clamped with a set of clamps, and for each mold set, a volume of EcoFlex 20 part A, an equal or substantially equal volume of EcoFlex 20 part B, and a volume of skin pigment adequate for opaque dyeing are combined in a mixing container and mixed thoroughly, followed by de-gassing in a vacuum chamber until the silicone deflates. As an example, for approximately 1 mold, the volume of EcoFlex 20 utilized may be about 15 mL or another volume, and about 0.15 mL of skin pigment may be utilized or another volume. The silicone 40A, 40B, 40C is aspirated into a syringe and slowly injected into the mold 38, stopping injection once silicone is extruding out of the open air port, as shown in FIG. 11. Any remaining silicone can be injected at the fill port to slowly fill the mold and remove air during the curing process, which curing will be for about 2 hours or such other curing time as may be suggested in the manufacturer's technical data sheet.

### Anterior Skin Post-Mold Stage

Consumables for the post-mold stage include (per 1 mold) a volume of EcoFlex 30 part A, an equal or substantially equal volume of EcoFlex 30 part B, a volume of hearty pigment adequate for opaque dyeing, a volume of skin post L, a volume of skin post R, a volume of EcoFlex Gel part A (that is equal or substantially equal to the volume of EcoFlex utilized), a volume of EcoFlex Gel part B (that is equal or substantially equal to the volume of EcoFlex utilized), and yellow pigment adequate for opaque dyeing, a volume of Psycho Paint™ part A and a volume of Psycho Paint part B (that is equal or substantially equal to the volume of Psycho Paint utilized). As an example, the volume of EcoFlex 30, EcoFlex Gel and Psycho Paints utilized may be about 2 mL or another volume.

The clamps are removed, and the excess silicone trimmed from the top of the mold. The sides of the mold are carefully separated using a screwdriver. Additional care should be taken to release the silicone trapped in the air ports.

Per 1 Lip, a volume of EcoFlex 30 part A, an equal or substantially equal volume of EcoFlex 30 part B, and a volume of hearty pigment adequate for opaque dyeing are combined in a mixing container and mixed thoroughly, followed by de-gassing in a vacuum chamber until the silicone deflates. As an example, the volume of EcoFlex 30 utilized may be about 1 mL or another volume, and about 0.1 mL of hearty pigment may be utilized or another volume. The silicone is then aspirated into a syringe. The skin mold has a pocket, which is pulled open and the silicone slowly injected therein until about 1-2 mm from being level with the top of the opening, being careful not to overfill. The skin is then placed against another object to ensure the top of the pocket remains level. A skin post is added to properly stretch the skin, and any excess silicone is wiped away that may have dripped out, followed by curing for about 30 minutes or another curing time as may be suggested by the manufacturer's technical data sheet, or a curing time as is required for the silicone to fully harden.

Per 1 Lip, a volume of EcoFlex 30 part A, an equal or substantially equal volume of EcoFlex 30 part B, and a volume of hearty pigment adequate for opaque dyeing are combined in a mixing container and mixed thoroughly, followed by de-gassing in a vacuum chamber until the silicone deflates. As an example, the volume of EcoFlex 30 utilized may be about 1 mL or another volume, and about 0.1 mL of hearty pigment may be utilized or another volume. The silicone is aspirated into a syringe. The skin is flipped over and a pocket of the skin mold is pulled open and the silicone slowly injected therein until about 1-2 mm from being level with the top of the opening, being careful not to overfill. The skin is placed against another object to ensure the top of the pocket remains level, and the skin post is added to properly stretch the skin. Excess silicone is wiped away where it has dripped out, and curing occurs for 30 minutes (and repeat on the other side), or for another curing time as suggested by the manufacturer's technical data sheet. Flashing is removed using a pair of snippers.

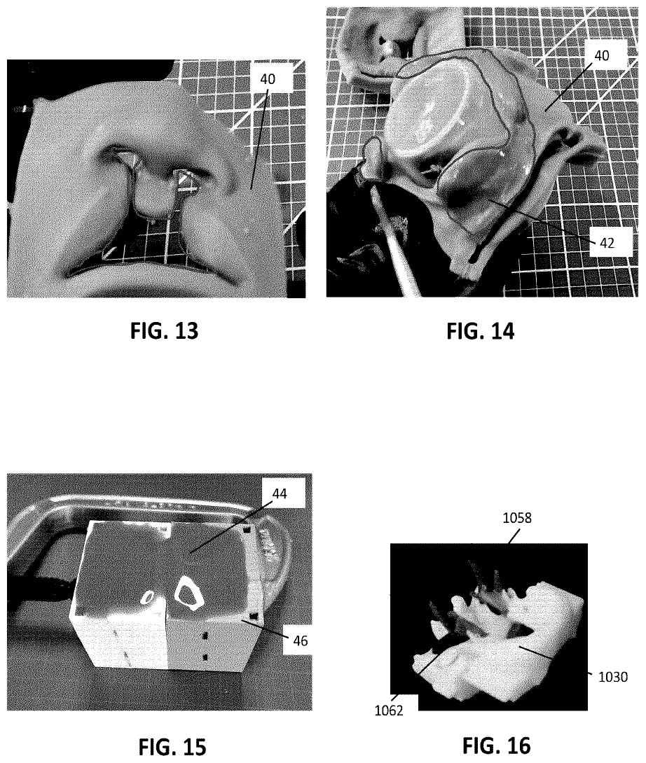

Per 5 molds, a volume of EcoFlex Gel part A, an equal or substantially equal volume of EcoFlex Gel part B, and a volume of yellow pigment adequate for opaque dyeing are combined in a mixing container and mixed thoroughly, followed by de-gassing in a vacuum chamber until the silicone deflates. As an example, the volume of EcoFlex Gel utilized may be about 2 mL or another volume. The silicone is aspirated into a syringe. The pocket in the simulated prolabium skin 40 is pulled open and silicone 42 injected therein until it fills the core of the pocket, as shown in FIG. 12. The silicone is allowed to cure, and flashings are removed from the prolabium skin 40, as shown in FIG. 13.

Per 5 molds, a volume of Psycho Paint part A, an equal or substantially equal volume of Psycho Paint part B, and a volume of hearty pigment adequate for opaque dyeing are combined in a mixing container and mixed thoroughly, followed by de-gassing in a vacuum chamber until the silicone deflates. As an example, the volume of Psycho Paint utilized may be about 1 mL or another volume, and the volume of hearty pigment utilized may be about 0.2 mL or another volume. Using a fine paint brush, the back of the lips 40 are gently painted with silicone 42, as shown in FIG. 14. Any excess silicone is removed. The simulated lip tissue are prevented from making contact by wrapping them around the base of medicine cups. Curing takes about 15 minutes or such other time as required for silicone to fully adhere to the lip. The steps of this paragraph are then repeated on the opposite side.

### Soft Palate TVP Mold

Consumables per 1 mold include a volume of EcoFlex 20 part A, an equal or substantially equal volume of EcoFlex 20 part B, and a volume of hearty pigment adequate for translucent dyeing. As an example, the volume of EcoFlex 20 utilized may be about 5 mL or another volume, and the volume of hearty pigment utilized may be about 0.05 mL or another volume.

The molds are clamped with the set of clamps. For each mold set, a volume of EcoFlex 20 part A, an equal or substantially equal volume of EcoFlex 20 part B, and a volume of hearty pigment adequate for translucent dyeing are combined in a mixing container and mixed thoroughly, followed by de-gassing in a vacuum chamber until the silicone deflates. As an example, the volume of EcoFlex 20 utilized may be about 5 mL or another volume, and the volume of hearty pigment utilized may be about 0.05 mL or another volume. The silicone is aspirated into a syringe and slowly injected into the mold, followed by curing for about 1 hour or another curing time as indicated on the manufacturer's technical data sheet. The mold is slowly opened with a pry tool, knife or flat-head screwdriver, and any excess silicone is trimmed.

### Soft Palate PP+PG Mold

Consumables per 1 mold include a volume of EcoFlex 20 part A, an equal or substantially equal volume of EcoFlex 20 part B, and a volume of hearty pigment adequate for translucent dyeing. As an example, the volume of EcoFlex 20 utilized may be about 5 mL or another volume, and the volume of hearty pigment utilized may be about 0.05 mL or another volume.

The molds are clamped with the set of clamps. For each mold set, a volume of EcoFlex 20 part A, an equal or substantially equal volume of EcoFlex 20 part B, and a volume of hearty pigment are combined in a mixing container and mixed thoroughly, followed by de-gassing in a vacuum chamber until the silicone deflates. As an example, the volume of EcoFlex 20 utilized may be about 5 mL or another volume, and the volume of hearty pigment utilized may be about 0.05 mL or another volume. The silicone is aspirated into a syringe and slowly injected into the mold, followed by curing for about 1 hour or another curing time as indicated in the manufacturer's technical data sheet. The mold is slowly opened with a pry tool, knife or flat-head screwdriver, and any excess silicone is trimmed.

### Soft Palate LVP Mold

Consumables per 1 mold include a volume of EcoFlex 30 part A, an equal or substantially equal volume of EcoFlex 30 part B, and a volume of hearty pigment adequate for opaque dyeing. As an example, the volume of EcoFlex 30 utilized may be about 7 mL or another volume, and the volume of hearty pigment utilized may be about 0.3 mL or another volume.

The molds are clamped with the set of clamps. For each mold set, a volume of EcoFlex 30 part A, an equal or substantially equal volume of EcoFlex 30 part B, and a volume of hearty pigment adequate for opaque dyeing are combined in a mixing container and mixed thoroughly, followed by de-gassing in a vacuum chamber until the silicone deflates. As an example, the volume of EcoFlex 30 utilized may be about 7 mL or another volume, and the volume of hearty pigment utilized may be about 0.3 mL or another volume. The silicone is aspirated into a syringe and slowly injected into the mold, followed by curing for about 1 hour or another curing time as indicated in the manufacturer's technical data sheet. The mold is slowly opened with a pry tool, knife or flat-head screwdriver, and any excess silicone is trimmed.

### Soft Palate LVP Mold

Consumables for another soft palate LVP mold include a volume of EcoFlex 30 part A, an equal or substantially equal volume of EcoFlex 30 part B, and a volume of hearty pigment adequate for opaque dyeing. As an example, the volume of EcoFlex 30 utilized may be about 7 mL or another volume, and the volume of hearty pigment utilized may be about 0.3 mL or another volume.

The molds are clamped with the set of clamps. For each mold set, a volume of EcoFlex 30 part A, an equal or substantially equal volume of EcoFlex 30 part B, and a volume of hearty pigment adequate for opaque dyeing are combined in a mixing container and mixed thoroughly, followed by de-gassing in a vacuum chamber until the silicone deflates. As an example, the volume of EcoFlex 30 utilized may be about 7 mL or another volume, and the volume of hearty pigment utilized may be about 0.3 mL or another volume. The silicone is aspirated into a syringe and slowly injected into the mold, followed by curing for about 30 minutes or another curing time as indicated in the manufacturer's technical data sheet. The mold is slowly opened with a pry tool, knife or flat-head screwdriver, and any excess silicone is trimmed.

### Soft Palate OC Mold

Consumables per 1 mold include a volume of EcoFlex 20 part A, an equal or substantially equal volume of EcoFlex 20 part B, and a volume of skin pigment adequate for opaque dyeing. As an example, the volume of EcoFlex 20 utilized may be about 20 mL or another volume, and the volume of skin pigment utilized may be about 0.4 mL or another volume.

The molds are clamped with the set of clamps. For each mold set, a volume of EcoFlex 20 part A, an equal or substantially equal volume of EcoFlex 20 part B, and a volume of skin pigment adequate for opaque dyeing are combined in a mixing container and mixed thoroughly, followed by de-gassing in a vacuum chamber until the silicone deflates. As an example, the volume of EcoFlex 20 utilized may be about 20 mL or another volume, and the volume of skin pigment utilized may be about 0.4 mL or another volume. The silicone 46 is aspirated into a syringe and slowly injected into the mold, slightly overfilling the mold 44, as shown in FIG. 15, followed by curing for about 30 minutes or another curing time as may be indicated in the manufacturer's technical data sheet. The mold is slowly opened with a pry tool, knife or flat-head screwdriver, and any excess silicone is trimmed.

### Soft Palate Assembly

Consumables per simulated nose includes primer, Loctite glue, LVP right and left, TVP right and left, PP+PG right and left, the SC, the OC, the bony cartridge, and paper towel.

The cartilage is laid out on clean paper towel and surfaces to be attached are primed. Glue is applied to the surfaces of PP+PG left to be attached to LVP left. Using tweezers, LVP is carefully placed on the glued surface, with straight medial edges of both muscles aligned. This is repeated for PP+PG right and LVP right.

The glued PP+PG/LVP is then attached to the bony cartridge. Attachment surfaces on both the simulated muscles and the bony cartridge are first primed, specifically the lateral curved edge of the PP muscle and the corresponding bony surface, the anterior edge of the PG muscle and the corresponding bony surface, and the posterior tip of the LVP muscle and the corresponding bony surface. Glue is applied to the surface of the bone cartridge to be attached to the PP muscle. The lateral curved edge of the PP muscle is attached to the medial edge of the bony cartridge, with the top surface of the PP muscle flush with the top surface of the bony cartridge and the medial edges of the PP muscle and bony cartridge aligned. Glue is applied to the posterior surface of the Hamulus, and the anterior edge of the PG muscle is attached to the posterior surface of the Hamulus. Glue is applied to the posterior divot and posterior half surface of the Eustachian tube. The free end of the LVP muscle in placed in the divot, along the Eustachian tube. These steps are repeated for the opposite side.

All glued surfaces should be secure, otherwise primer should be re-applied and glue should be repeated.

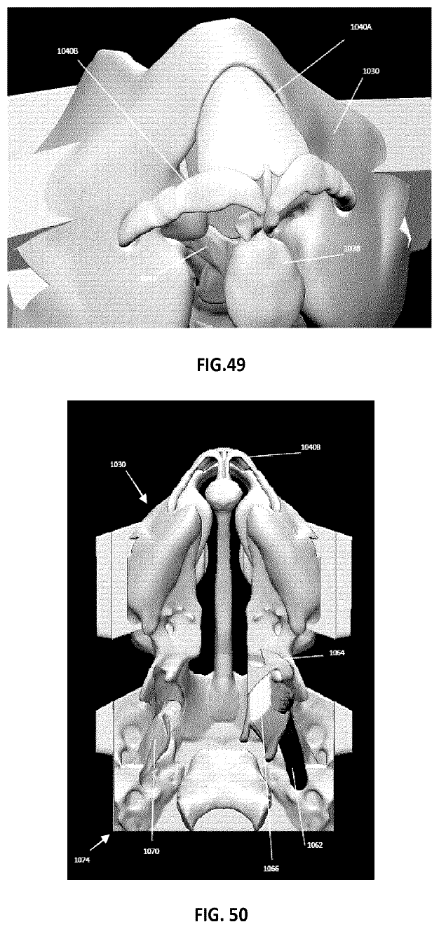

Mold release should be applied to the top surface of the PP+PG muscles bilaterally (FIG. 49), and a simulated fat layer applied. The front of the bony cartridge should be propped up such that the surface of the PP muscle is level.

In a mixing cup, for example such as a 1 oz. cup, a volume of Dragon Skin FX-PRO—Part A, an equal or substantially equal volume of Dragon Skin FX-PRO—Part B, and a small amount of yellow pigment adequate for translucent dyeing are combined and mixed well with a stick, followed by de-gassing (2 minutes in a vacuum chamber). As an example, the volume of Dragon Skin FX-PRO utilized may be about 1 mL or another volume. As shown in FIG. 16, the muscle elements can be attached to the bony cartridge. The silicone is applied bilaterally to the surface of the PP+PG muscles with a paintbrush. The medial edge of the simulated fat should align with the medial edge of the PP/LVP muscles (i.e., the fat should not overhang). Posteriorly, the fat should not cover the uvula. Anteriorly, the fat should end a few millimeters posterior to the bony cartridge. The simulated fat should not cover any bony surface. Curing follows for about 40 minutes or another curing time as indicated in the manufacturer's technical data sheet.

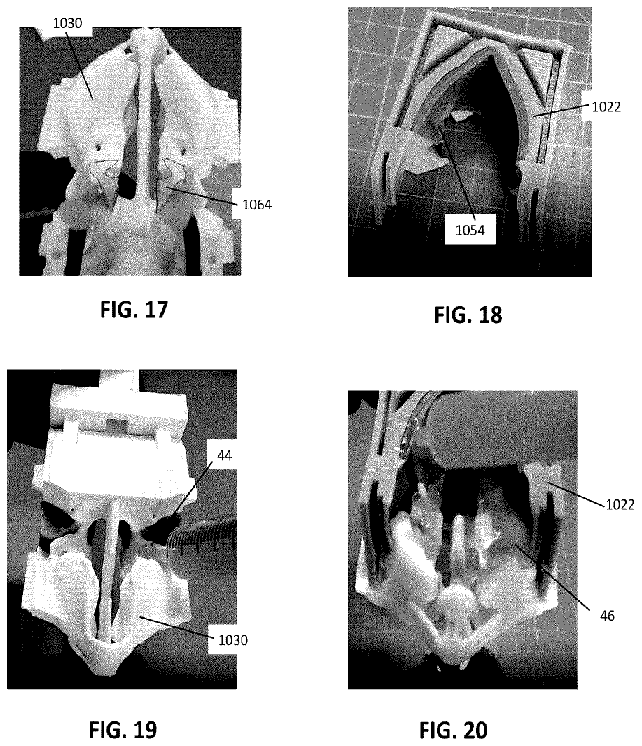

The TVP muscle is then attached, as shown in FIG. 17. Attachment surfaces are first primed (the entire surface of the TVP muscle, and for the palate the fat, PP muscle and bony area between the Hamulus and greater palatini foramen, as well as the bony groove for the TVP muscle).

The TVP muscle is put in place to be attached. The muscle body should fit into the bony groove, and the anterior fibres/aponeurosis should be pulled back to allow for application of glue. The anterior fibres are then glued, followed by the aponeurosis. The anterior edge should abut with the slight ridge on the bony palate (between the Hamulus and the greater palatini foramen). The medial edge of the aponeurosis should align with the medial edge of the fat/PP/LVP. All edges should be well secured, and the remaining edges (muscle body) should be glued in place.

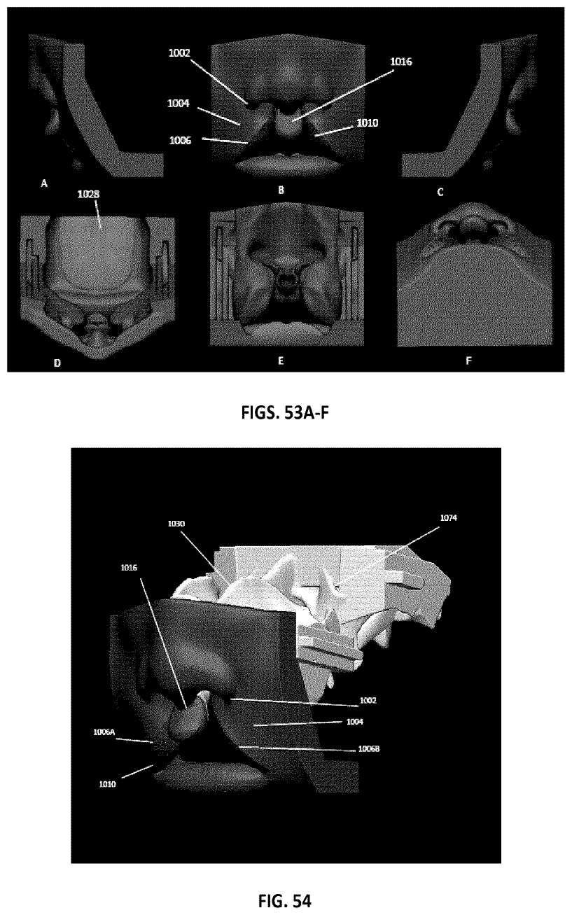

With reference to FIGS. 53 and 54, the SC and OC are now attached. All attachment surfaces are primed—for the SC this would be all of the posterior surface, pegs, anterolateral edges, superior edges, and inferior edge, and for the OC this would be all corresponding surfaces.

The SC is placed into the OC, as shown in FIG. 18, ensuring that the pegs on the SC fit into corresponding divots in the OC. One at a time, the pegs are glued in place. One at a time, the anterolateral edges of the SC are glued such that they abut with the ridges on the OC. All remaining edges of the SC are secured in place with glue.

### Gluing Skin

The skin is attached to the exemplary simulator, for example, the skin can be glued or attached by other attachment means.

The combined OC and SC is attached to the combination bony cartridge and muscles. All attachment surfaces are primed, and the bony cartridge is placed into the OC. All abutting surfaces are glued, beginning with the posterior side and working around anteriorly. The PP and PG muscles should be attached to the SC after the bony cartridge is secure. The OC should be attached to the Hamulus last (to the tip and lateral side of the Hamulus). Mold release is then applied, being brushed liberally onto all outer surfaces of the OC, being careful to avoid all bony surfaces. The mold release applied in this step allows for the removal of excess silicone after the mucosa is applied, as describe hereinbelow. All silicone surfaces that are not covered in mucosa on the completed simulator will need a coat of mold release. The septum of the nose cartilage should be brushed. Very carefully, mold release is applied to the posterior SC, the tips of the PP and PG muscles, and the nasal side of the LVP muscle, being careful to avoid the oral side of soft palette and the medial pterygoid plate.

Simulated mucosa is then applied. The simulator is rotated until the nasal side faces up. The mucosa is formed in three layers.

For the first layer, a volume of Dragon Skin FX-PRO—Part A, an equal or substantially equal volume of Dragon Skin FX-PRO—Part B, a volume of mucosa-like pigment adequate for translucent dyeing are combined and mixed well with a stick, followed by de-gassing (5 minutes in a vacuum chamber). As an example, the volume of Dragon Skin FX-PRO utilized may be 15 mL or another volume. With a small syringe, the silicone mixture is drawn up. The syringe is placed directly into the greater palatini foramen of the hard palate 1030 and the silicone injected until silicone 44 is dripping out below, as shown in FIG. 19. This repeated for the other foramen. This is applied to cover all bony surfaces on the nasal side. Rotation is then restarted, and the remaining silicone is drawn up from the mixing container. While the simulator is still rotating, silicone 46 is injected onto both medial pterygoid plates and to cover all surfaces on the oral side including the SC, soft palette and hard palate, as shown in FIG. 20. A stick is used to even out the silicone to create an even layer over all components. Excess silicone is removed from the lateral SC, any drips are removed, and any excess from the anterior margin of the cleft. A needle may be used to remove excess silicone between the uvula and the SC, ensuring separation of these two structures. Curing follows for about 20 minutes or another curing time as indicated in the manufacturer's technical data sheet.

For the second layer, the general process is the same as the first layer but using a volume of Dragon Skin FX-PRO—Part A, an equal or substantially equal volume of Dragon Skin FX-PRO—Part B, a volume of mucosa-like pigment adequate for translucent dyeing (matching colour to the previous layer). As an example, the volume of Dragon Skin FX-PRO utilized may be 10 mL or another volume. This layer is not added to the premaxilla.

For the third layer the general process is the same as the first layer with a volume of Dragon Skin FX-PRO—Part A, an equal or substantially equal volume of Dragon Skin FX-PRO—Part B, a volume of mucosa-like pigment adequate for translucent dyeing (matching colour to the previous layers), and again not adding this layer to the premaxilla. As an example, the volume of Dragon Skin FX-PRO utilized may be 10 mL or another volume.

### Attach Anterior Skin

In a final stage, the anterior skin is attached to the simulator.

Consumables per nose include primer, Loctite glue, the skin mold, the cleft lip bony cartridge, paper towel, a volume of Dragon skin Fx-Pro part A, an equal or substantially equal volume of Dragon skin Fx-Pro part B, a volume of Thi-Vex adequate to increase viscosity, and mucosa-like pigment adequate for translucent dyeing. As an example, the volume of Dragon Skin FX-PRO utilized may be 10 mL or another volume, and the volume of Thi-Vex utilized may be 1 drop or another volume.

The simulated skin is laid out on clean paper towel and attachment surfaces are primed (on both bony lip and skin). The skin and corresponding bony surface of the perpendicular plate are primed. After the primer has dried, glue is applied to the surface of the skin to be attached to the cartridge, but applying only as much glue as is necessary. The glued skin is carefully placed on the glued surface.

For the lip cartridge, a volume of Dragon skin Fx-Pro part A, an equal or substantially equal volume of Dragon skin Fx-Pro part B, and magenta pigment adequate for translucent dyeing are combined in a mixing container and mixed thoroughly, followed by de-gassing in a vacuum chamber until the silicone deflates. As an example, the volume of Dragon Skin FX-PRO utilized may be 5 mL or another volume. A long-tip syringe is filled with the silicone mixture and silicone mixture is applied along the glued areas of the skin and cartridge. Curing follows for about 30 minutes, another curing time as indicated in the manufacturer's technical data sheet, or another time as required for the silicone to fully harden.

For a bilateral cartridge, a volume of Dragon skin Fx-Pro part A, an equal or substantially equal volume of Dragon skin Fx-Pro part B, a volume of Thi-Vex adequate to increase viscosity, and magenta pigment adequate for translucent dyeing are combined in a mixing container and mixed thoroughly, followed by de-gassing in a vacuum chamber until the silicone deflates. As an example, the volume of Dragon Skin FX-PRO utilized may be 5 mL or another volume, and the volume of Thi-Vex utilized may be 1 drop or another volume. A syringe is filled with the silicone mixture, and the mixture is injected between the skin and the cartridge and placed against a wall. Curing follows for approximately 30 minutes, another curing time as indicated in the manufacturer's technical data sheet, or another time as required for the silicone to fully harden, in some embodiments of the present invention.

### Invention Elements

The simulator of the present invention incorporate two key elements, a cartridge and a cartridge base. These elements, their sub-elements and the assembly and function of each to form the simulator of the present invention are described below. The description is an example of an embodiment of the present invention and variations thereof are possible to form other embodiments of the present invention.

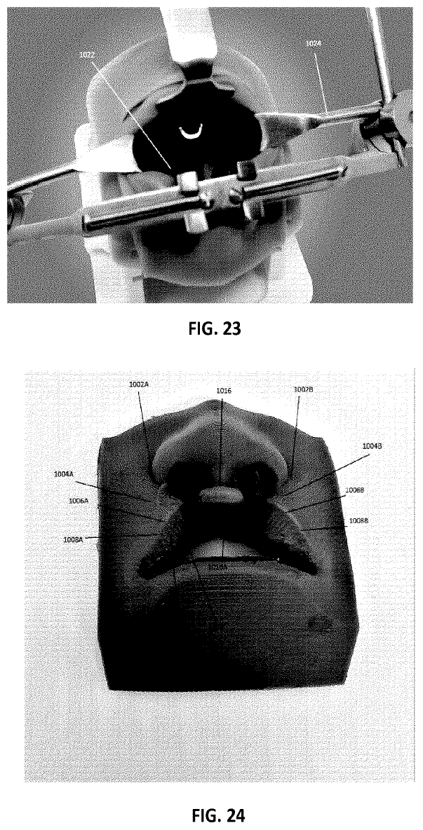

The cleft lip and palate elements can be configured into a bilateral cleft lip cartridge 1020. The cartridge may be removably connected to a base element 1014 to form the fully assembled simulator, as shown in FIG. 23. When connected to the base element a surgical procedure may be performed upon the cartridge element. The base element provides stability for the elements in the cartridge during such surgical procedure, or during any other cleft lip and palate training for which the simulator may be utilized.

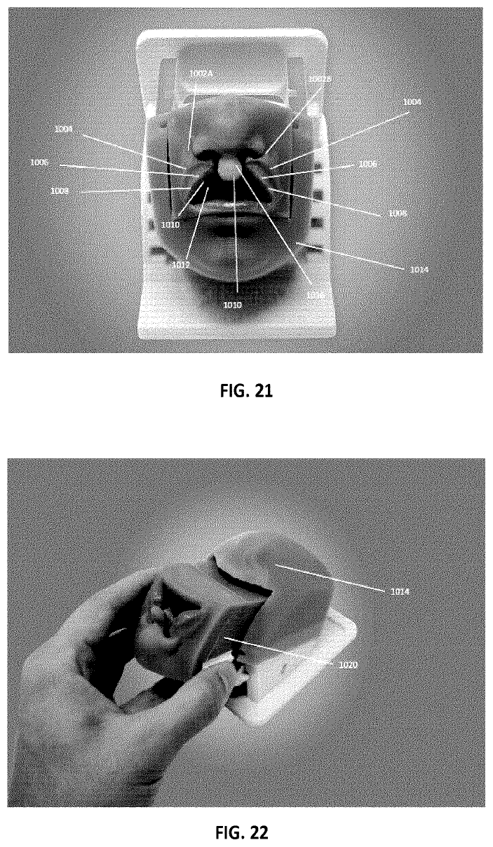

As shown in FIG. 21, when fully assembled, the cartridge that incorporates the cleft lip and palate elements is inserted into the cartridge base 1014. A skin element may be attached to the portion of the base in a manner to create skin extended from the skin element of the cartridge when the cartridge is inserted in the base. This skin attached to the base assists in creating a larger face portion than is created merely by the cartridge, and can assist in the look and feel of surgical procedures, as well as other training, for which the simulator is utilized.

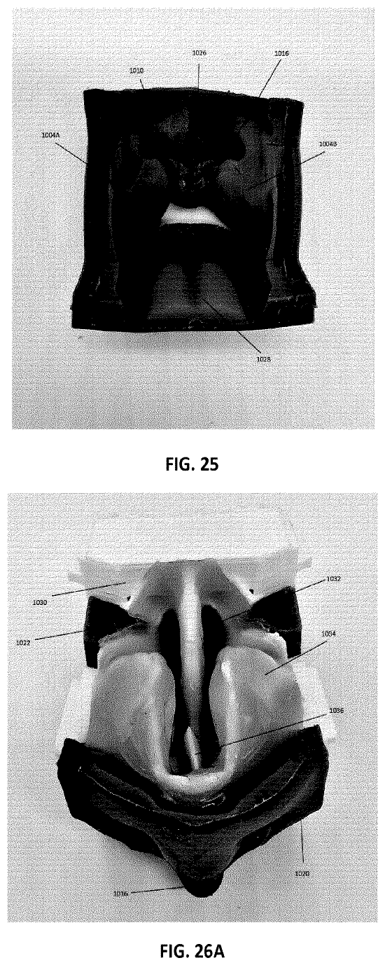

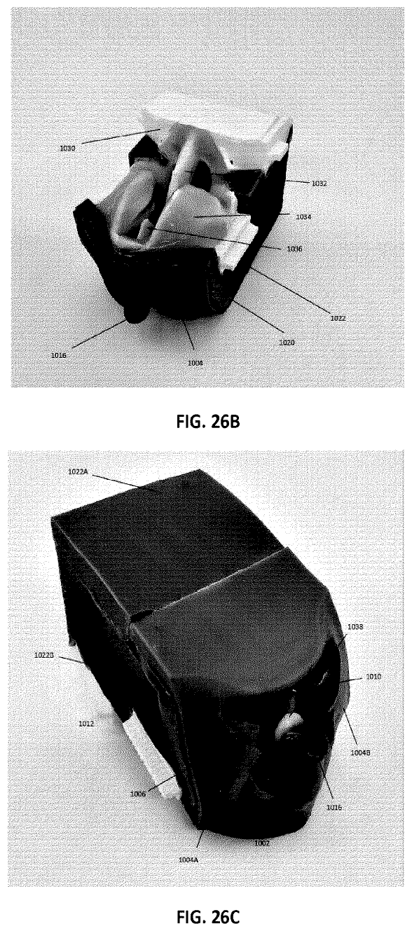

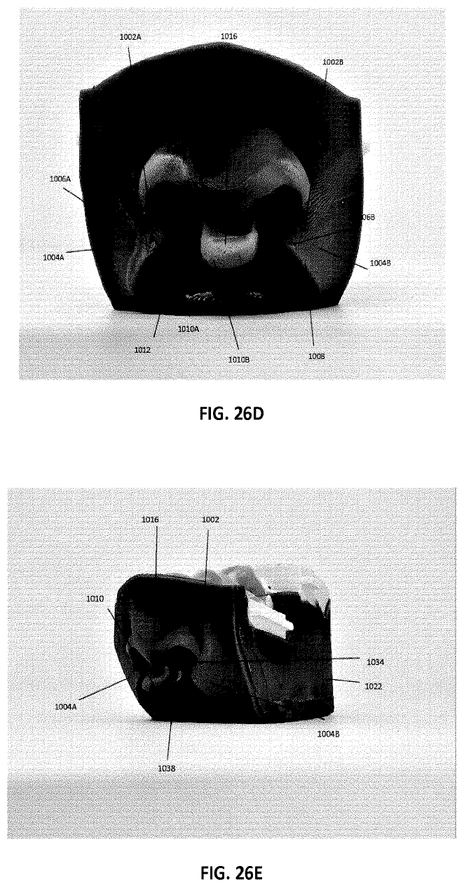

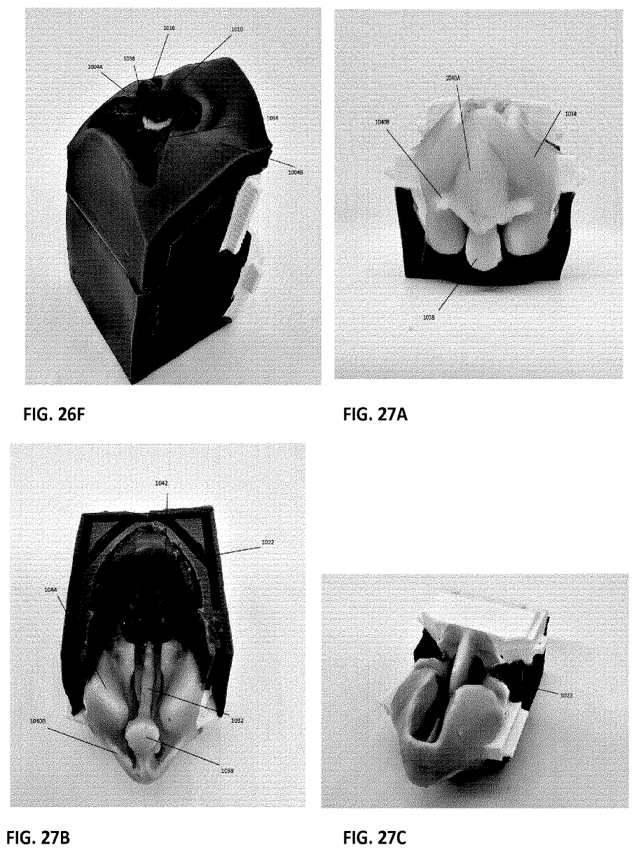

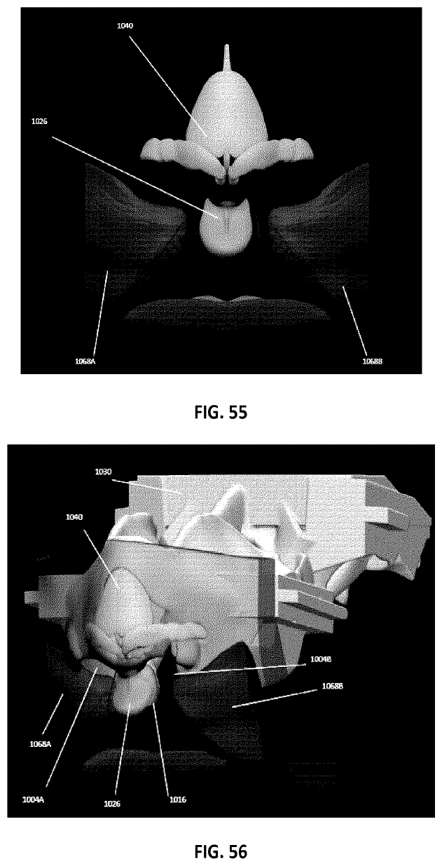

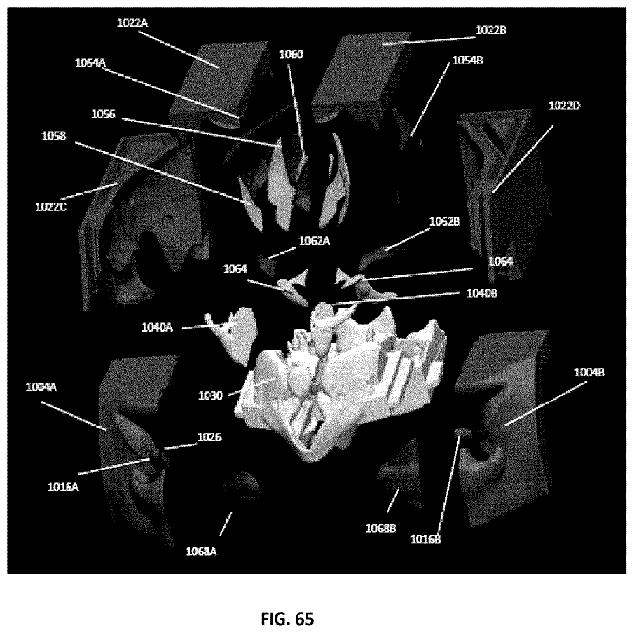

The cartridge comprises multiple elements, including several that are visible to a user upon the exterior surface of the cartridge, including a lateral lip element 1004, a cutaneous roll 1006, a vermillion, which further comprises a vermillion cutaneous junction 1008 and a vermillion mucosal junction 1012, a prolabium 1016, and an alar base. Some of these elements, but not all elements, are mirrored on both sides of the cartridge in relation to the nose and mouth elements formed therein. These elements may be formed in an anterior layer of skin that is attached to the outer surface of the cartridge, as shown in FIG. 25. The interior view of the skin layer is provided in FIG. 26, showing the forming of such element of the cartridge from the interior of the cartridge. This view includes the tongue 1028 which is visible from an exterior view of the cartridge but is internal to the cartridge. Several other elements are also internal to the cartridge, as discussed herein. The skin layer and the elements formed therein are shown in FIGS. 54A-F from a variety of angles and perspective views. The skin layer is connectable to the hard palate through a connection at the prolabium 1016, in the assembled cartilage, as shown in FIGS. 55 and 64. As shown in FIG. 65, elements may be positioned between the skin and other internal elements of the cartridge, such as orbicularis oris 1068 and subcutaneous tissue 1026.

As shown in FIG. 24, the assembled simulator of the present invention facilitates the practice of a surgical procedure thereupon by a user through access to the oral cavity 1022 and the use of surgical tools, including but not limited to a scalpel, retractors (for example, such as a Dingman retractor 1024), and other surgical tools.

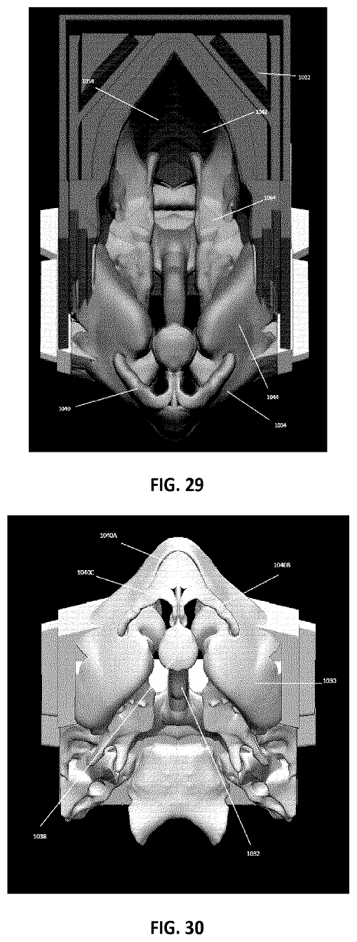

The cartridge can be formed to incorporate a removable lid section 1022A, as shown in FIGS. 60A-F. When the lid section is removed access to and visibility of internal elements of the cartridge occurs. The cartridge may be utilized for some types of training when the cartridge lid is removed, such as identification of elements and the interaction thereof of cleft lip and palate conditions. FIGS. 29A-I further show the cartridge 1050, having the oral cavity lid section removed from the oral cavity 1022, from a variety of angles and perspective views.

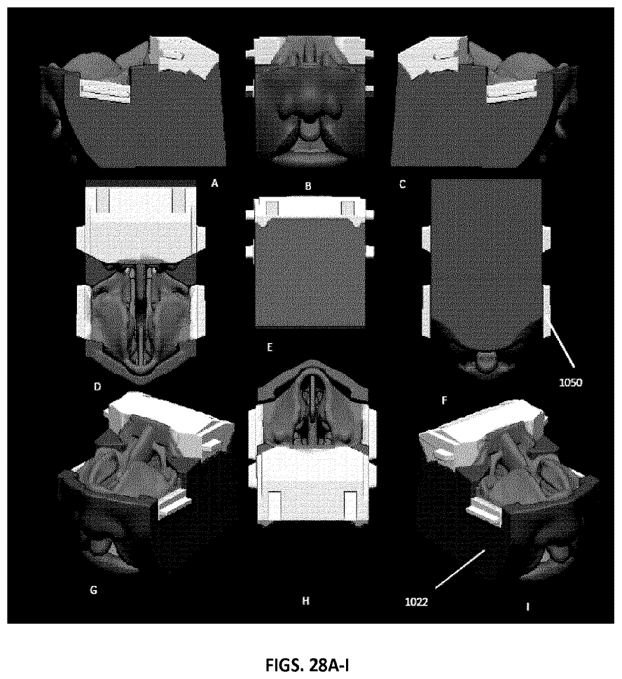

As shown in FIGS. 27A and 27B, elements internal to the cartridge can include a hard palate 1030, an oral cavity 1022, a vomer 1032, mucosa 1034, and a septal cartilage 1036. When the oral cavity lid section is attached, as shown in FIG. 27C such elements are no longer visible to a user of the cartridge and are enclosed within the interior of the cartridge. A view showing how some internal elements of the cartridge are visible when the oral cavity lid is removed from the cartridge is shown in FIGS. 52 and 53. The specific elements that are external to the front of a cartridge are shown in FIGS. 27D-27F.

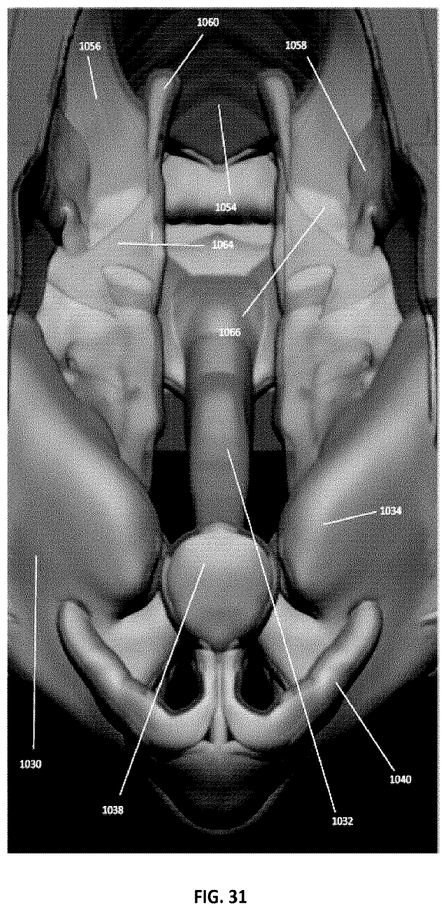

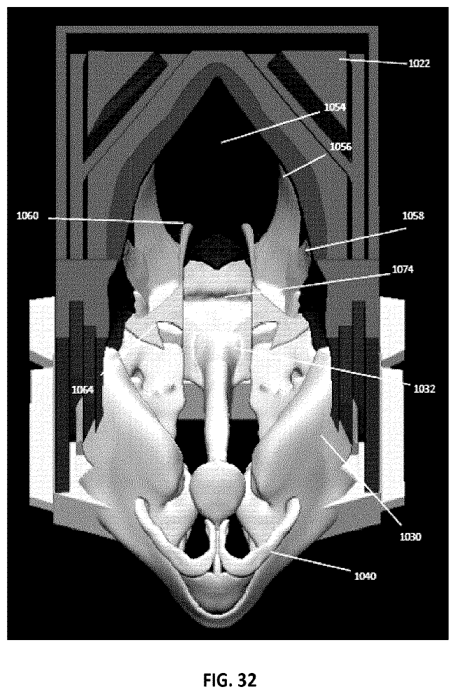

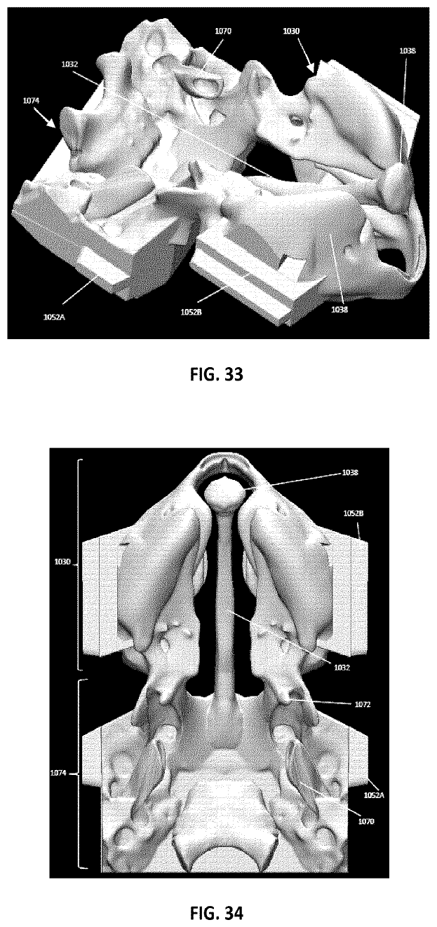

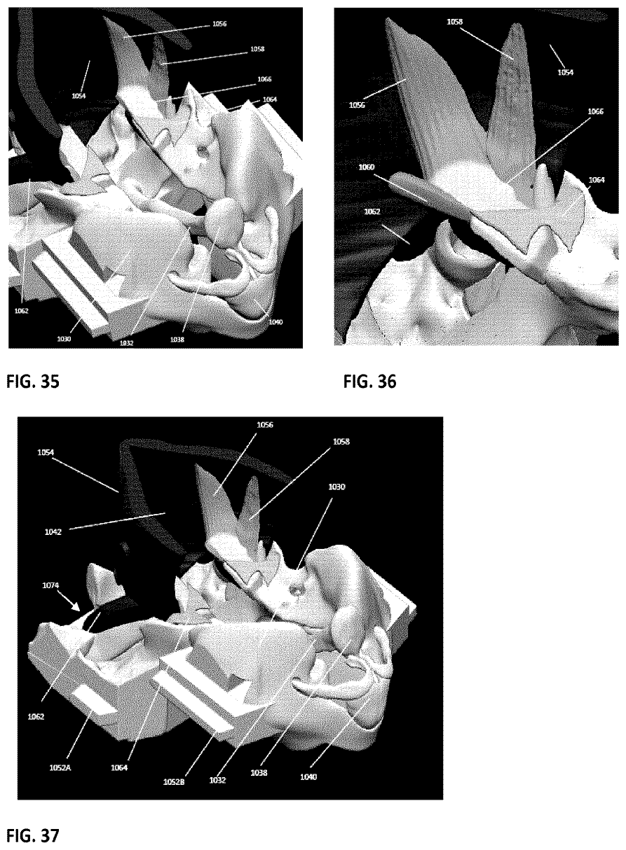

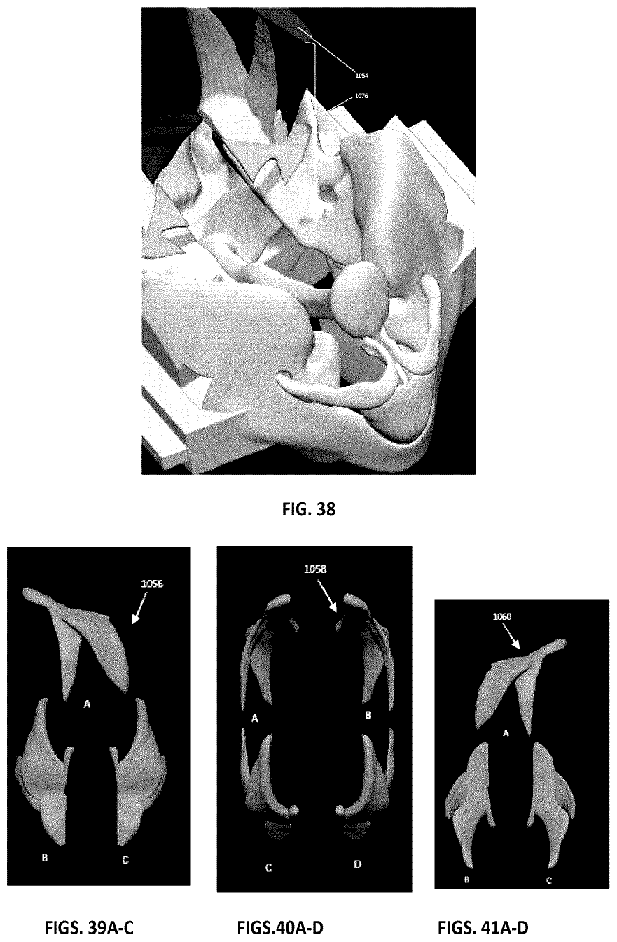

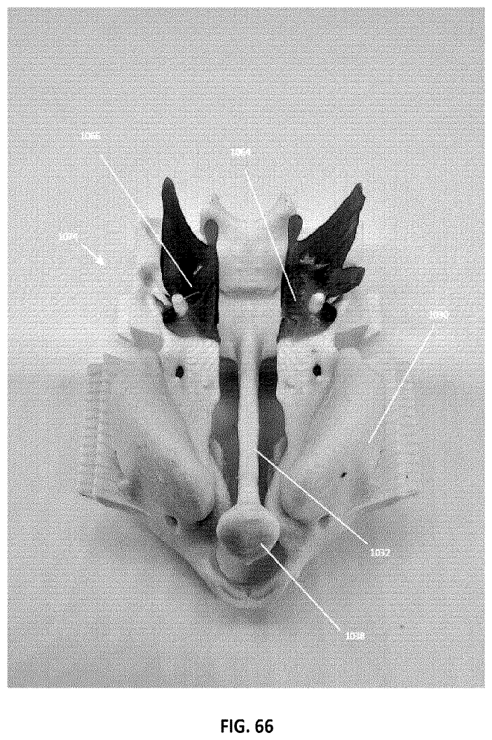

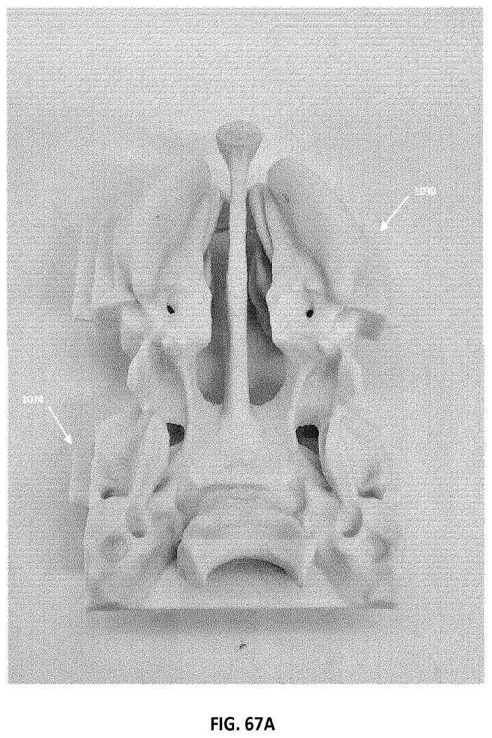

As shown in FIGS. 28A-28C, 30-38 and 66 other elements may further be internal to the cartridge, including lateral cartilage which may include lower lateral cartilage 1040B and upper lateral cartilage 1040A, a hard palate 1044 (which may be bony in texture), soft palate musculature section 1042, a superior constrictor muscle 1054, a tensor veli palatini muscle 1064, a hard bony palate 1044, nasal cartilage 1040, a premaxilla, a palatopharyngeus muscle, a musculus uvula, a palatoglossus muscle, a fatty tissue layer 1066. Moreover, such elements may be attached or otherwise incorporated within sections of the cartridge that form a cranial base 1074 and a hard palate 1030, as shown in FIGS. 33-35 and 68A-C. Each section may incorporate specific elements, for example, the cranial base may incorporate an Eustachian tube portion 1070 and a Hamulus 1072, and the hard palate may incorporate a premaxilla and a vomer.

Both the hard palate and the cranial base of the cartridge may incorporate sliding rails 1052A, 1052B which may be utilized to position the cartridge within the cartridge base, whereby the sliding rails which protrude from the cartridge engage and fit within grooves formed in the interior wall of the cartridge base. The sliding rails may further be configured to augment the stability of the cartridge when it is attached to the cartridge base.

Elements of the present invention may be formed individually and assembled, as described herein, and may further be grouped. As an example, as shown in FIG. 37, the palatoglossus muscle 1058, palatopharyngeus muscle 1056, musculus uvula 1060, and levator veli palatini muscle 1062 can be collectively grouped to form the soft palate musculature 1042 (referenced in FIGS. 30 and 39). The palatopharyngeus muscle 1056 is shown as formed individually in FIGS. 40A-C, from a variety of angles and perspective views. The palatoglossus muscle 1058 is shown as formed individually in FIGS. 41A-D, from a variety of angles and perspective views.

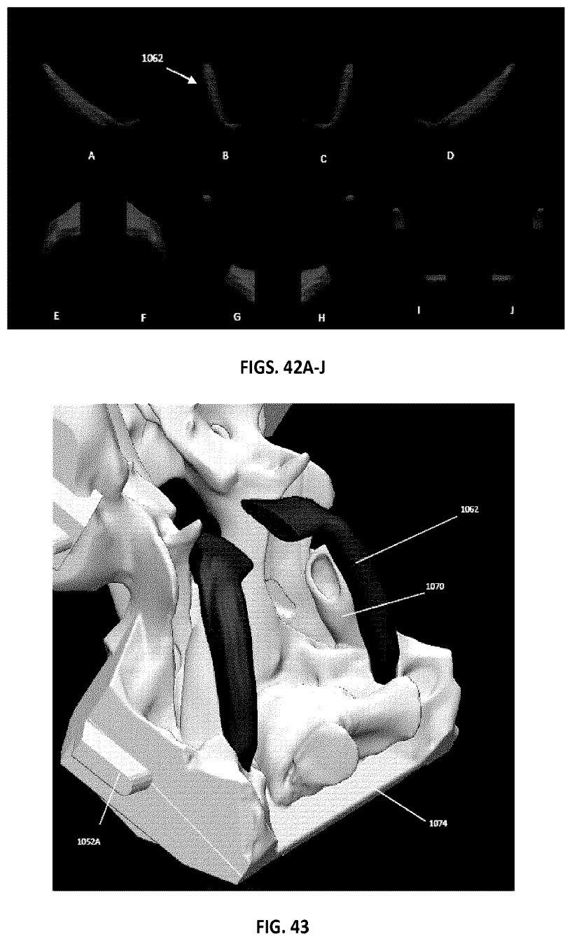

The palatoglossus muscle 1058 is shown as formed individually in FIGS. 41A-D, from a variety of angles and perspective views. The musculus uvula 1060 is shown as formed individually in FIGS. 42A-C, from a variety of angles and perspective views. The levator veli palatini muscle 1062 is shown as formed individually in FIGS. 43A-J, from a variety of angles and perspective views. Moreover, as shown in FIGS. 37 and 39, these elements are positioned in relation to each other, and in a manner whereby they are layered, and achieve an interaction between the elements.

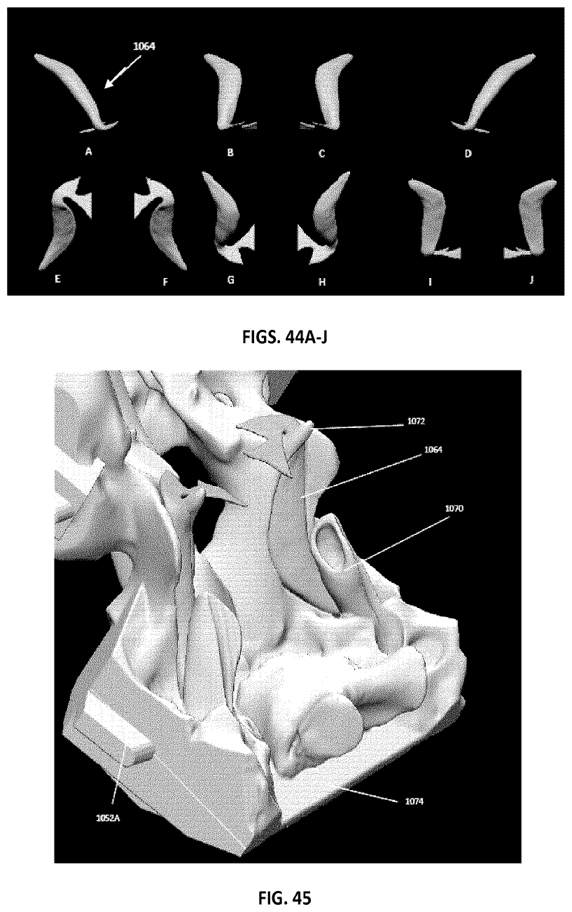

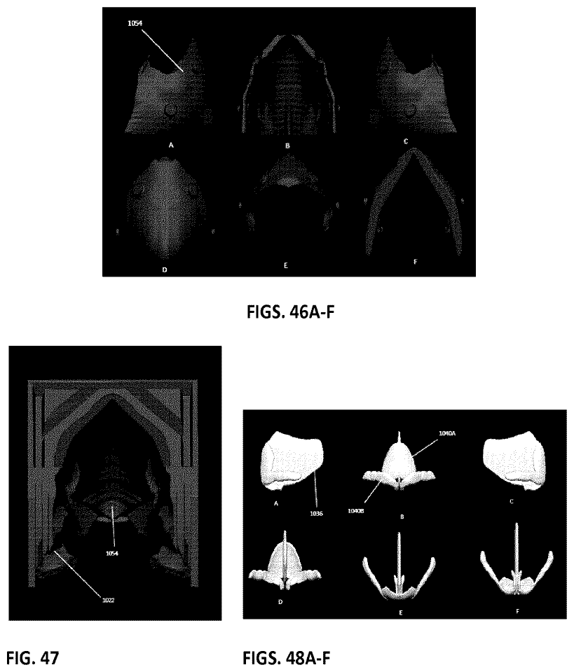

The drawings further indicate the connections between elements, as well as the overall positioning of the elements when fully assembled. For example,
FIG. 44 shows the connection of the levator veli palatini muscle 1062 to the cranial base 1074, and that such connection causes such muscle to have a particular position in relation to the Eustachian tube 1070. The connection and positioning of each element creates a specific interaction of that element with other elements of the invention.
FIG. 46 provides a view of the connection of tensor veli palatini muscles to the cranial base, and the positioning of such muscle in relation to the Eustachian tube 1070 and the Hamulus 1072. FIGS. 45A-J further shows the tensor veli palatini muscle as formed individually from a variety of angles and perspective views.
FIG. 48 provides a view of the connection of a superior constrictor muscle to the interior wall of the oral cavity 1022. FIGS. 47A-F further shows the superior constrictor muscle as formed individually from a variety of angles and perspective views.
FIG. 50 provides a view of the connection of a nasal cartilage 1040 (including the upper lateral cartilage 1040A and the lower lateral cartilage 1040B) to the hard palate 1030, and that such positioning causes such cartilage to have a particular position in relation to the premaxilla 1038 and vomer 1032. FIGS. 49A-F further shows the nasal cartilage (including the upper lateral cartilage 1040A, lower lateral cartilage 1040B, and septal cartilage 1036) as formed individually from a variety of angles and perspective views.

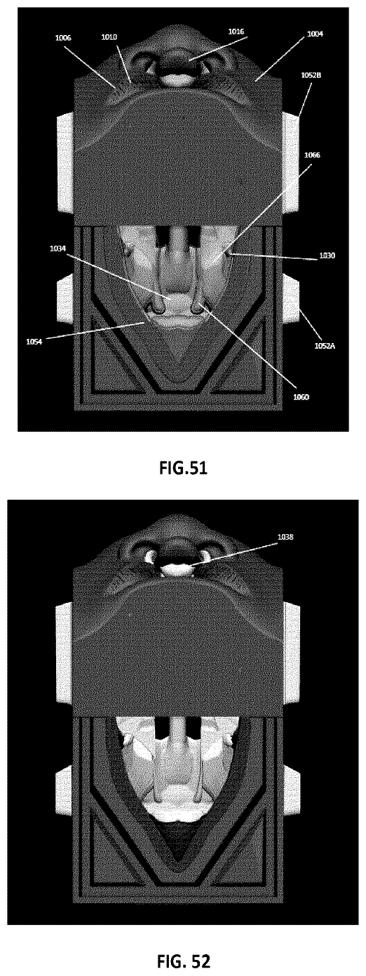

FIG. 51 shows both the levator veli palatini muscle 1062 and the tensor veli palatini muscle 1064 attached to the cranial base, and how these elements are layered in accordance with such connection and positioning in relation to the cranial base, which further create a relationship and interaction between the levator veli palatini muscle 1062 and the tensor veli palatini muscle 1064.

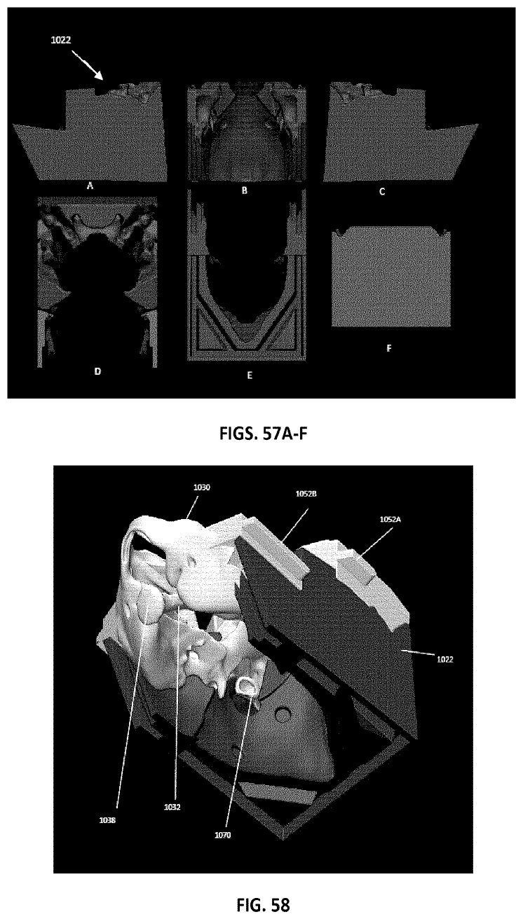

FIG. 56 provides a view of the connection between the skin layer and the nasal cartilage 1040, the subcutaneous tissue 1026, and the orbicularis oris 1068A 1068B. Once so connected the skin layer is attachable to the hard palate, as shown in FIG. 57.

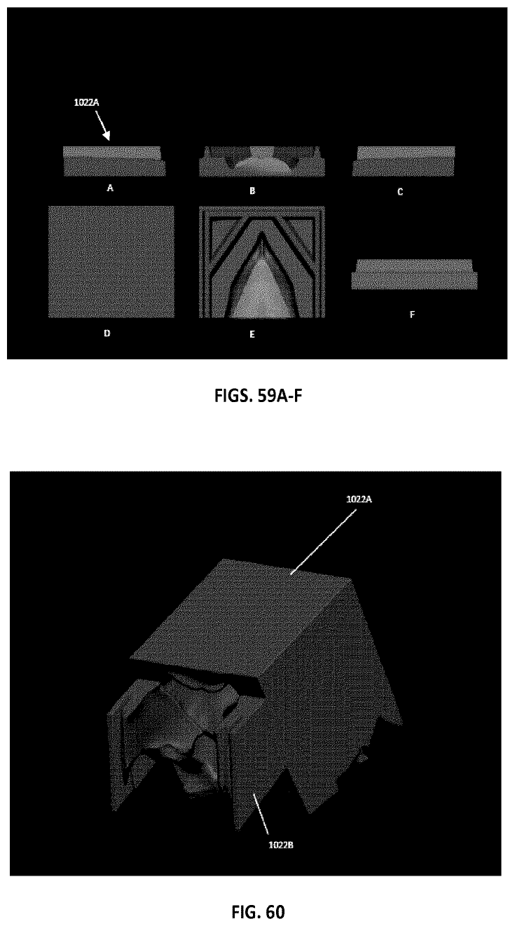

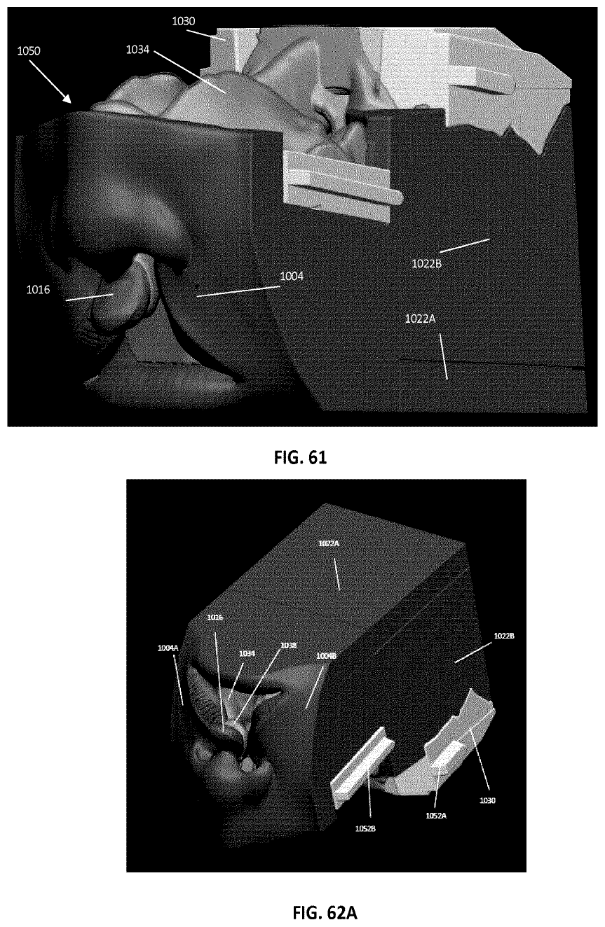

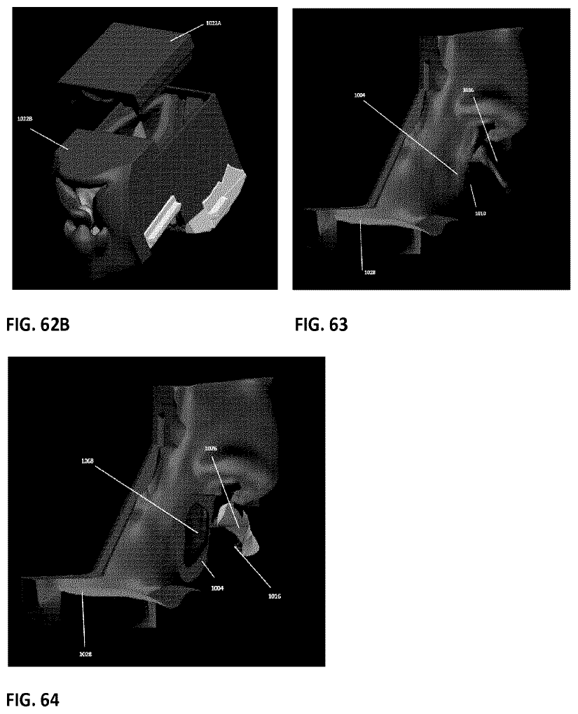

The hard palate and cranial base are connected to the oral cavity 1022, as shown in FIG. 59. The oral cavity is formed to incorporate 3 walls having an inner side whereby a connection to the hard palate and cranial base is achievable, and the outer side of such walls form the exterior of the cartridge, and are therefore attachable to the cartridge base, as shown in FIGS. 58A-F. Thus the oral cavity both assists in the anatomically complex configuration of the cartridge (via the formation of its inner walls) and creating a housing for the cartridge (via the formation of its outer walls). When the oral cavity lid 1022A is attached the oral cavity holds many of the elements of the cartridge within its internal space and thereby form a housing for such elements, as shown in FIG. 61. In another embodiment of the present invention, internal elements of the cartridge, including the hard palate 1030, and mucosa 1034, may be accessible when the oral cavity lid 1022A is attached to the oral cavity 1022, as shown in FIGS. 62 and 63A-B.

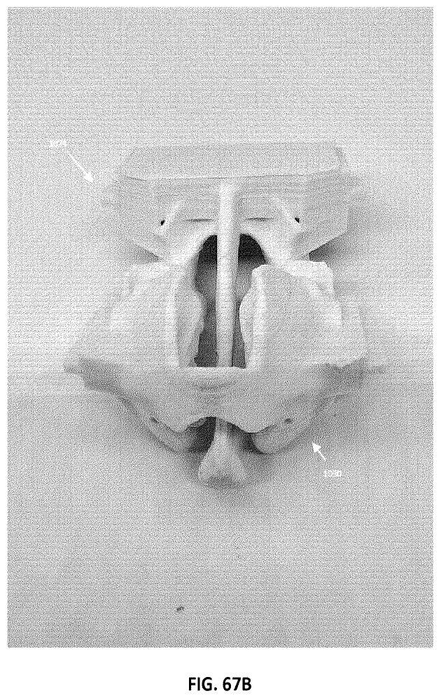

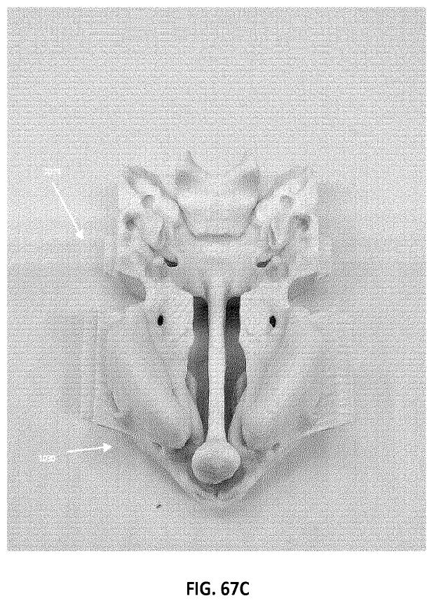

Embodiments of the present invention may include elements which may vary in regards to shape and size to reflect different characteristics of cleft lip and palate fields, such as fatty tissue layer 1066 attached to a tensor veli palatini muscle 1064, as shown in FIG. 67.

### Method

The simulator can be utilized for the purpose of training regarding surgical procedures relating to cleft lip and palate conditions, and other training relating to such condition. For example, present invention allows performance of a bilateral cleft lip repair from start to finish using real surgical instruments. The following procedural steps can be performed on the simulator when it is fully assembled.

The prolabium and lateral lip elements may be marked for any type of bilateral cleft lip repair technique. Such marks can be drawn upon the skin or other elements of simulator and the marks can be utilized for guidance during the surgical procedure performed upon the simulator.

An incision through the skin of the prolabium down towards subcutaneous tissue can be made utilizing a surgical blade tool. The prolabium may be de-epithelialization to widen the prolabium base. An incision along the vermillion mucosal junction of the prolabium can be made for the purpose of removing tissue, and once such incision is completed tissue may be removed.

A dissection between the mucosa and subcutaneous layer may be made to create the posterior wall of the upper labial sulcus. Incisions can be made through the skin of the lateral lip elements 1004 down towards the orbicularis oris muscles. Dissection can be made of the muscle of the lateral lip elements from skin and mucosa. The muscle may be detached from their abnormal insertion into the alar base 1002.

Incision of upper gingivobuccal sulcus incisions through the mucosa may be performed to advance the lateral lip elements medially. The accessory cartilage-lower lateral cartilage complex may be released from the piriform rims to advance the lateral nose anteriorly.

Bilateral lateral nasal wall flaps may be created through: elevation of the lateral mucoperiosteum from the lateral nasal wall; and incising the mucoperichondrium along the nasal floor laterally and creating a back cut from inferior to superior in the posterior aspect of the lateral nasal wall flap to allow advancement anteriorly.

Bilateral mucoperichondrial flaps may be created along the caudal septum by an incision along the caudal septal mucoperichondrium traversing from anterior to posterior.

Sutures may be applied including the following: suturing the lateral nasal wall flap to the septal flap to recreate the nasal floor; suturing of the prolabium mucosal flap to the premaxilla superiorly to create the posterior wall of the upper labial sulcus; suturing of bilateral mucosal flaps together and to the superior aspect of the premaxilla to create the superior apex of the upper labial sulcus; suturing the mucosa together from superior to inferior to create the anterior wall of the upper labial sulcus; suturing the muscle together in the midline to reconstitute the muscle; and suturing the skin together to complete the repair.

These steps, or other steps involved in other cleft lip and palate surgical procedures, when performed on the present invention will have a similar feel to performance of the same steps upon a human cleft lip and plate, due to the materials utilized to form the simulator. The similar characteristics of the materials utilized to form the elements of the present invention simulator to the corresponding human facial elements further allows for the use of the same tools upon the simulator as can be utilized upon a human cleft lip and palate in a surgical procedure.

The foregoing is considered as illustrative only of the principles of the present invention. The scope of the claims should not be limited by the exemplary embodiments set forth in the foregoing, but should be given the broadest interpretation consistent with the specification as a whole.

1. A simulator for practicing bilateral cleft lip and palate surgery, comprising:
a simulated premaxilla bone; and
a simulated prolabium tissue separably attached to the simulated premaxilla bone.

2. The simulator of claim 1 wherein the simulated premaxilla bone is part of a simulated bony cartridge.

3. The simulator of claim 2 further comprising a simulated nose cartilage which is attached to the simulated bony cartridge, with a portion of the simulated nose cartilage attached to the simulated premaxilla bone.

4. The simulator of claim 2 further comprising a simulated orbicularis oris muscle attached to the simulated bony cartridge.

5. The simulator of claim 1 further comprising a multilayer simulated anterior skin comprising the simulated prolabium tissue, the simulated prolabium tissue comprising a pocket for receiving a simulated fat tissue.

6. The simulator of claim 1 further comprising simulated soft palate right and left tensor veli palatini muscles, simulated right and left palatopharyngeus and palatoglossus muscles, simulated right and left levator veli palatini muscles, a simulated oral cavity, and a simulated superior constrictor muscle.

7. The simulator of claim 6 wherein the simulated right and left palatopharyngeus and palatoglossus muscles are attached to the simulated right and left levator veli palatini muscles to form a muscle assembly, and the muscle assembly is attached to the simulated bony cartridge to form a muscle/bony cartridge assembly.

8. The simulator of claim 7 further comprising a simulated fat layer applied to the muscle assembly but not applied to the simulated bony cartridge.

9. The simulator of claim 6 wherein the simulated soft palate right and left tensor veli palatini muscles are attached to the simulated bony cartridge.

10. The simulator of claim 7 wherein the simulated superior constrictor muscle is attached to the simulated oral cavity to form a muscle/cavity assembly, and wherein the muscle/cavity assembly is attached to the muscle/bony cartridge assembly.

11. The simulator of any one of claims 1 to 10 further comprising a simulated mucosa applied on all exposed surfaces.
